(19) United States
(12) Patent Application Publication
(10) Pub. No.: US 2010/0149157 A1
(43) Pub. Date: Jun. 17, 2010

(54) ACTIVE MATRIX DISPLAY AND METHOD FOR DRIVING THE SAME

(75) Inventors: Ming-Chia Shih, Rende Township (TW); Fu-Chi Yang, Tainan City (TW); Chia-Hang Lee, Toucheng Township (TW); Chao-Jen Huang, Anding Township (TW)

Correspondence Address: FISH & RICHARDSON PC, P.O. BOX 1022, MINNEAPOLIS, MN, 55440-1022, US

(73) Assignee: CHI MEI OPTOELECTRONICS CORPORATION, Tainan (TW)

(21) Appl. No.: 12/636,389

(22) Filed: Dec. 11, 2009

(30) Foreign Application Priority Data
Dec. 12, 2008 (TW) 97148640

(51) Int. Cl. G09G 5/00

(52) U.S. Cl. 345/211; 345/55

(57) ABSTRACT

An active matrix display and a method for driving the display are provided. During a first scan period, a first scan line and a second scan line of the active matrix display are both at a high voltage level so that a first pixel electrode of the display is electrically connected to a data line of the display, and a second pixel electrode of the display is electrically connected to the first pixel electrode. During a second scan period, the first scan line is at the high voltage level while the second scan line is at a low voltage level so that the first pixel electrode is electrically connected to the data line and the second pixel electrode is electrically disconnected from the first pixel electrode.

### CROSS-REFERENCE TO RELATED APPLICATIONS

This application claims priority to Taiwan application Serial No. 097148640, filed Dec. 12, 2008, the contents of which are incorporated herein by reference.

### BACKGROUND

The subject matter is generally related to a display panel, and more particularly, to a display panel with a high aperture ratio.

In an example liquid crystal display (LCD), an active matrix driving circuit is configured to control the display panel to enable images to be shown on the display panel.

FIG. 1 is a circuit diagram of a portion of a conventional active matrix display 40, and FIG. 2 illustrates the circuit layout of the active matrix display 40 in FIG. 1. Referring to FIGS. 1 and 2, the active matrix display 40 has pixels 42 arranged in an array. The active matrix display 40 includes an active matrix driving circuit for controlling each pixel 42. The active matrix driving circuit includes scan lines Sₙ to Sₙ₊₃ and data lines Dₘ-Dₘ₊₅ that are arranged perpendicular to each other, and each pixel 42 includes a thin film transistor (TFT) Q that functions as a switch.

The TFT Q can be an N-type or P-type field effect transistor (FET) and has three electrodes: a gate electrode, a first source/drain electrode, and a second source/drain electrode. The gate and first source/drain of the TFT Q corresponding to each pixel 42 are respectively coupled to a scan line and a data line. Taking the pixel 42 at the top left corner of the figure as an example, the gate of the TFT Q corresponding to the pixel 42 is coupled to the scan line Sₙ, the first source/drain of the TFT Q is coupled to the data line Dₘ, and the second drain/source of the TFT Q is coupled to a pixel electrode 44 of a pixel capacitor Cp of the pixel 42. As shown in FIGS. 1 and 2, the scan lines Sₙ-Sₙ₊₃ are respectively disposed between every two rows of the pixels 42, and the data lines Dₘ-Dₘ₊₅ are respectively disposed between every two columns of the pixels 42.

An example liquid crystal display is disclosed in the article titled “Display Electronics Required for AMLCDs with Pixel Level Data-Line Multiplexing” (Society for Information Display (SID) DIGEST, pages 1236-1239) that was published by Manabu et al. in 2003. FIG. 3 is an equivalent circuit diagram of the display array disclosed by Manabu et al., and FIG. 4 shows timing diagrams of control signals used for controlling the display array in FIG. 3. Referring to FIGS. 3 and 4, each of the pixels A1 to D2 includes a storage capacitor Cs, and 3 transistors T1 to T3 are provided for every two of the pixels A1-D2. Taking the pixels A1 and B1 as an example, the two pixels are coupled to the data line D(m) through the transistors T1 and T3, respectively. The gate of the transistor T1 is coupled to the first source/gate of the transistor T2, the gates of the transistors T2 and T3 are coupled to the scan line G(n+1), and the second source/gate of the transistor T2 is coupled to the next scan line G(n+2) through a conductive line 32.

As shown in FIG. 4, the voltage on each of the scan lines G(n) to G(n+3) changes over time so that the transistors T1 to T3 are turned on at predetermined time periods and the data voltage on the data lines D(m) and D(m+1) are supplied to the pixels A1 to D2 at specific time periods. For example, during the period t1, the voltage on the data line D(m) is supplied to the pixels A1 and B1, during the period t2, the voltage on the data line D(m) is supplied to the pixel B1, during the period t3, the voltage on the data line D(m) is supplied to the pixels C1 and D1, and during the period t4, the voltage on the data line D(m) is supplied to the pixel D1.

In the display array disclosed by Manabu et al., each of the transistors T2 has a gate connected to one scan line (e.g., G(n)) and a source/drain connected to another scan line (e.g., G(n+1)) through the conductive lines 32. In the display array disclosed by Manabu et al., three transistors T1 to T3 are used for every two pixels.

### SUMMARY

In one aspect, in general, an active matrix display with a high aperture ratio and a method for driving the display are provided. For example, the active matrix display can include a first pixel electrode, a second pixel electrode, a data line, a first scan line, and a second scan line. The first scan line controls the electrical connection between the first pixel electrode and the data line, and the second scan line controls the electrical connection between the first pixel electrode and the second pixel electrode.

In another aspect, in general, a method for driving an active matrix display is provided, in which pixel voltages of a first pixel electrode and a second pixel electrode of the active matrix display are updated. The method can include the following steps. During a first scan period, a first scan line and a second scan line of the active matrix display are both maintained at a high voltage level so that the first pixel electrode is electrically connected to a data line of the active matrix display and the second pixel electrode is electrically connected to the first pixel electrode. During a second scan period, the first scan line is maintained at a high voltage level while the second scan line is maintained at a low voltage level so that the first pixel electrode is electrically connected to the data line of the active matrix display and the second pixel electrode is electrically disconnected from the first pixel electrode.

Implementations of the active matrix display can include one or more of the following features. The active matrix display can include a first transistor and a second transistor. The first transistor of the active matrix display can be turned on when the first scan line is at the high voltage level, and the second transistor of the active matrix display can be turned on when the second scan line is at the high voltage level. The source and the drain of the first transistor can be coupled to the first pixel electrode and the data line, the gate of the first transistor can be coupled to the first scan line, the source and the drain of the second transistor can be coupled to the first pixel electrode and the second pixel electrode, and the gate of the second transistor can be coupled to the second scan line.

The first pixel electrode and the second pixel electrode can be disposed between the first scan line and the second scan line. The first pixel electrode and the second pixel electrode can be disposed at different sides of the second scan line. The active matrix display can include a plurality of the first pixel electrodes and a plurality of the second pixel electrodes, and the first pixel electrodes and the second pixel electrodes can be arranged as flip pixels. The first pixel electrode and the second pixel electrode can have different pixel voltages. The first pixel electrode and the second pixel electrode can have areas of different sizes. The polarity of the data line can switch once every frame period. The polarity of the data line can switch once every two scan periods. The first pixel electrode and the second pixel electrode can have the same polarity, or different polarities. The first pixel electrode and the second pixel electrode can be covered by filter layers of the same color or different colors. The second scan period can be shorter than the first scan period.

When the first pixel electrode is electrically connected to the data line and the second pixel electrode is electrically disconnected from the data line, the first scan line can be at a first high level, and when the first pixel electrode and the second pixel electrode are both electrically connected to the data line, the first scan line and the second scan line can be both at a second high level, wherein the second high level is lower than the first high level. During each frame period, the first scan line and the second scan line can change from a high voltage level to a first low level and then change from the first low level to a second low level. When the first scan line is at the first low level or the second low level, the first pixel electrode can be electrically disconnected from the data line. When the second scan line is at the first low level or the second low level, the second pixel electrode can be electrically disconnected from the data line.

The active matrix display can have zero, one, or more of the following advantages. A first pixel electrode and an adjacent second pixel electrode in the same row can share the same data line, in which the second pixel electrode can be electrically connected to the data line through the first pixel electrode and the action of each pixel can be controlled by using a single switch so that the number of the data lines and the number of the switches can be reduced. Accordingly, the fabricating cost for the display can be reduced and the aperture ratio can be increased.

### BRIEF DESCRIPTION OF THE DRAWINGS

FIG. 1 is a circuit diagram of a portion of a conventional active matrix display.

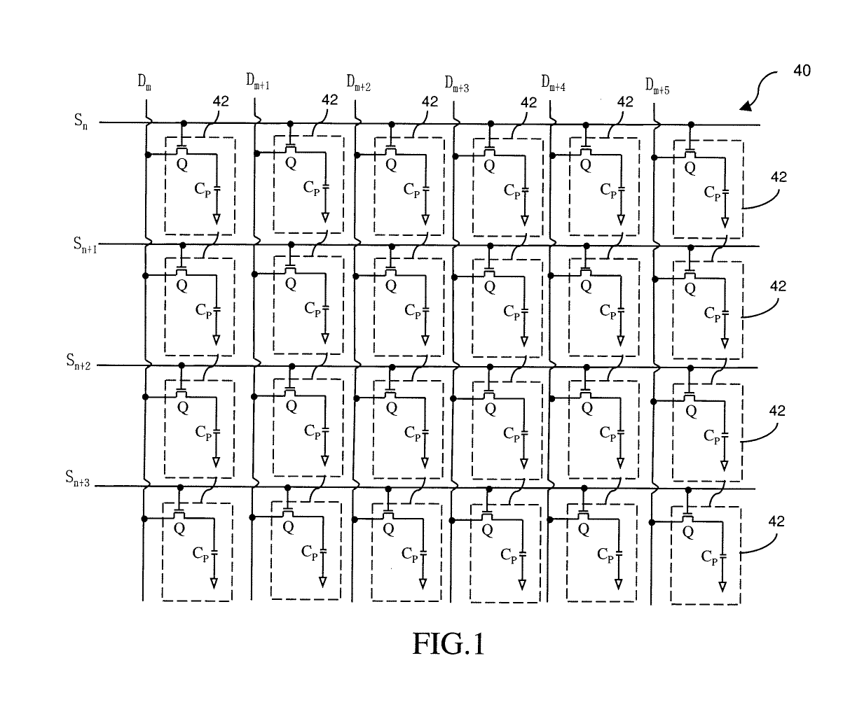

FIG. 2 illustrates the circuit layout of the active matrix display in FIG. 1.

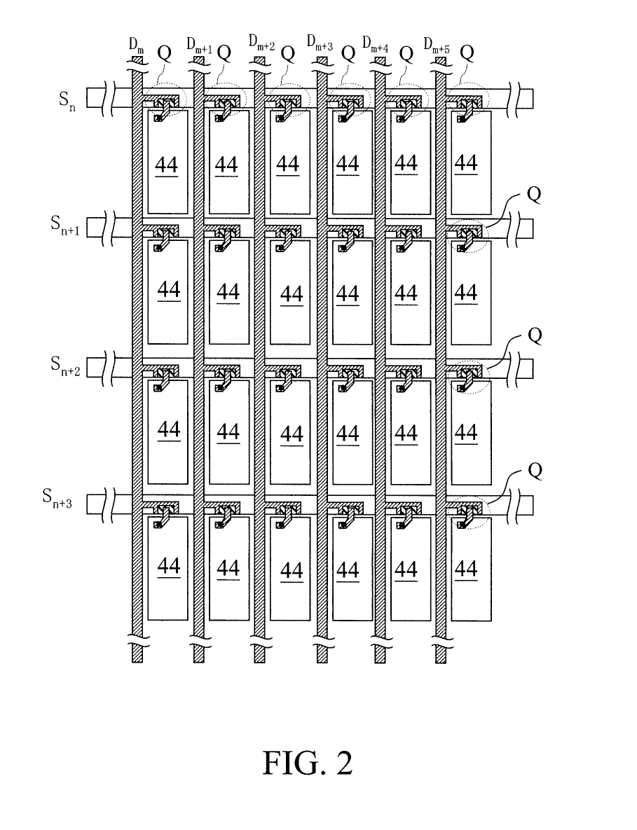

FIG. 3 is an equivalent circuit diagram of a display array disclosed by Manabu et al.

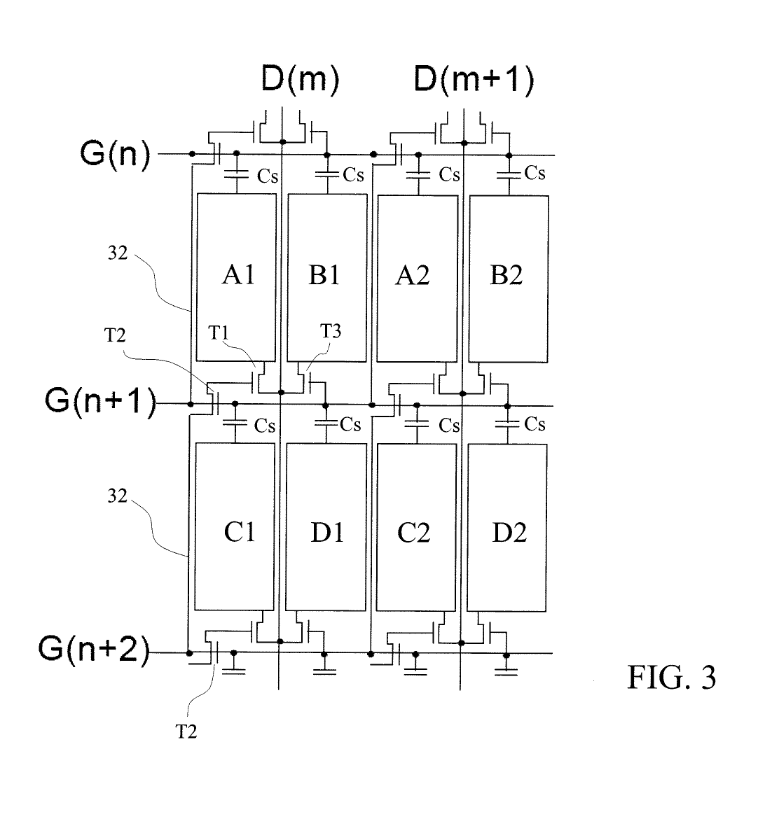

FIG. 4 is a timing diagram of control signals of the display array in FIG. 3.

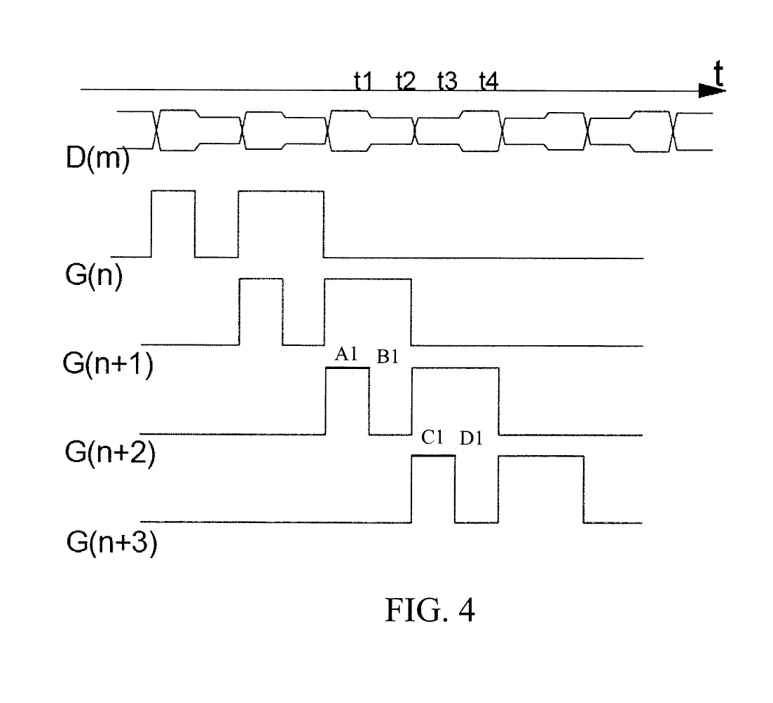

FIG. 5 illustrates the circuit layout of an active matrix display.

FIG. 6 is a circuit diagram of the active matrix display in FIG. 5.

FIG. 7 is a circuit diagram illustrating a method for driving the active matrix display in FIG. 5.

FIG. 8 is a timing diagram of control signals on scan lines of the active matrix display in FIG. 7.

FIG. 9 is a circuit diagram of an active matrix display.

FIG. 10 illustrates the circuit layout of an active matrix display.

FIG. 11 illustrates the circuit layout of an active matrix display.

FIG. 12 illustrates the circuit layout of an active matrix display.

FIG. 13 is a circuit diagram of the active matrix display in FIG. 11.

FIG. 14 is a circuit diagram illustrating a method for driving the active matrix display in FIG. 13.

FIG. 15 is a timing diagram of control signals on scan lines of the active matrix display in FIG. 11.

FIG. 16 is a timing diagram of control voltages on scan lines of an active matrix display.

FIG. 17 is a timing diagram of control voltages on scan lines of an active matrix display.

FIG. 18 is a circuit diagram of a portion of an active matrix display.

FIG. 19 is a timing diagram of scan voltages on scan lines of the active matrix display in FIG. 18.

FIG. 20 is a timing diagram of scan voltages on scan lines.

FIG. 21 is a circuit diagram of an active matrix display.

FIG. 22 illustrates the circuit layout of the active matrix display in FIG. 21.

FIG. 23 is a timing diagram of control signals of the active matrix display in FIG. 21.

FIG. 24 illustrates the circuit layout of an active matrix display.

FIG. 25 is a circuit diagram of the active matrix display in FIG. 24.

FIG. 26 is a timing diagram of control signals of the active matrix display in FIG. 24.

FIG. 27 is a timing diagram of control signals of the active matrix display in FIG. 5.

FIG. 28 illustrates the polarities of pixel electrodes of the active matrix display in FIG. 5.

FIG. 29 is a timing diagram of control signals of the active matrix display in FIG. 12.

FIG. 30 illustrates the polarities of pixel electrodes of the active matrix display in FIG. 12.

FIG. 31 is a schematic diagram of an example liquid crystal display panel.

### DETAILED DESCRIPTION

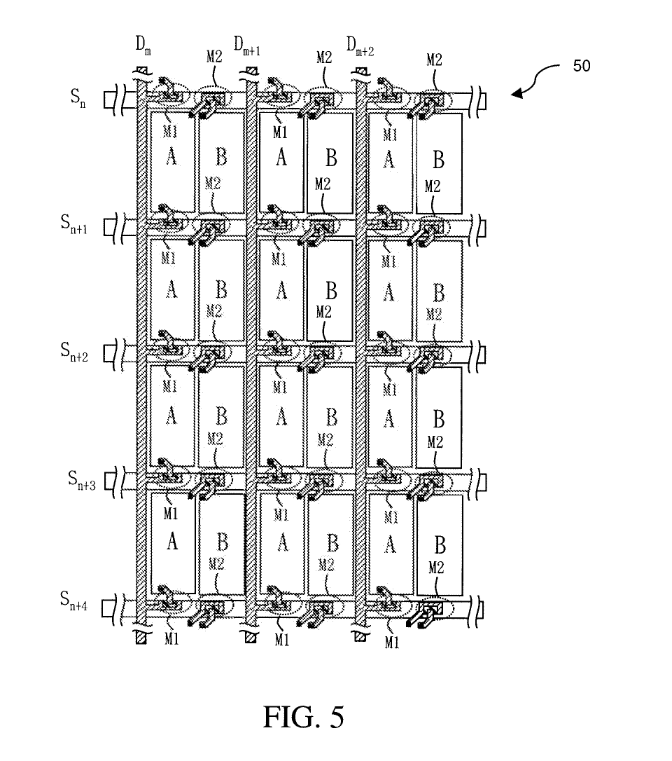

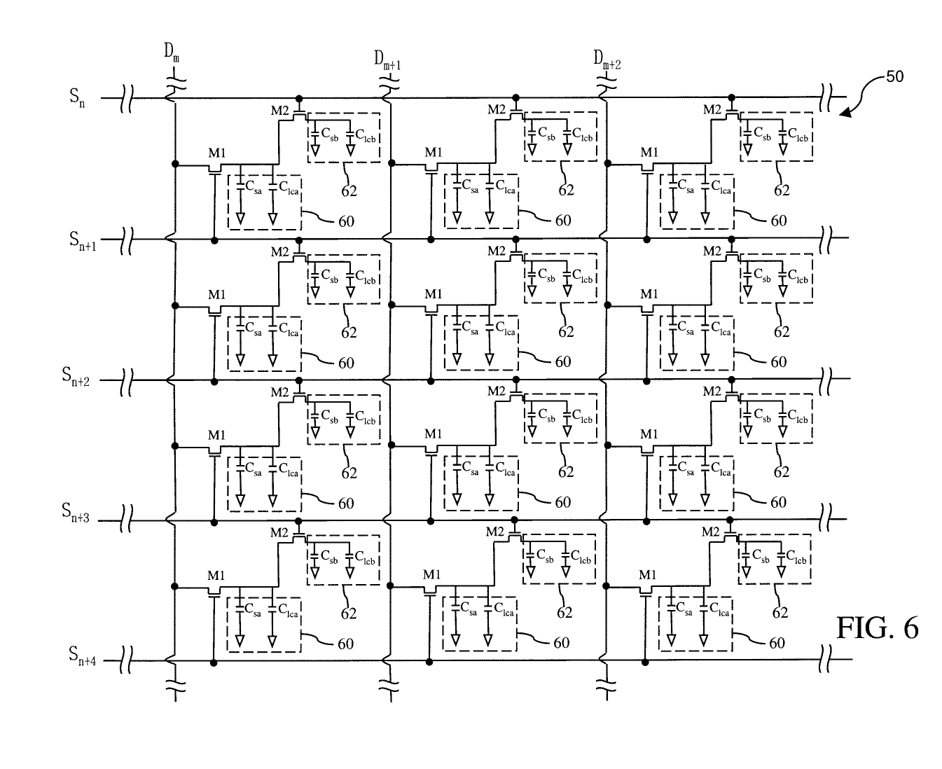

FIG. 5 illustrates the circuit layout of an example active matrix display 50, and FIG. 6 is a circuit diagram of the active matrix display 50 in FIG. 5. Referring to FIGS. 5 and 6, the active matrix display 50 includes first sub-pixels 60, second sub-pixels 62, first transistors M1, second transistors M2, data lines Dₘ-Dₘ₊₂, and scan lines Sₙ-Sₙ₊₄. The numbers of data lines, scan lines, and pixels can be different from those shown in FIGS. 5 and 6, and can be determined according to the desired resolution of the display.

In some examples in which the active matrix display 50 is a liquid crystal display, storage capacitor lines (not shown in FIG. 5) can be provided to reduce the variation of voltage level stored in the liquid crystal pixels caused by current leakage. A liquid crystal pixel is associated with a pixel capacitor C_{1c} that is formed by the pixel electrode and the common electrode of a liquid crystal cell, and a storage capacitor Cₛ that is formed by the pixel electrode and the storage capacitor line.

As shown in FIGS. 5 and 6, each first sub-pixel 60 is coupled to a corresponding first transistor M1 and has a first pixel capacitor C_{1ca} and a first storage capacitor Cₛₐ, and each second sub-pixel 62 is coupled to a corresponding second transistor M2 and has a second pixel capacitor C_{1cb} and a second storage capacitor C_{sb}. The first pixel capacitor C_{1ca} has a first pixel electrode A coupled to the corresponding first transistor M1, and the second pixel capacitor C_{1cb} has a second pixel electrode B coupled to the corresponding second transistor M2. The first storage capacitor Cₛₐ and the first pixel capacitor C_{1ca} store the charges used for controlling the gray scale level of the first sub-pixel 60. The second storage capacitor C_{sb} and the second pixel capacitor C_{1cb} store the charges used for controlling the gray scale level of the second sub-pixel 62.

For each first transistor M1, the gate is coupled to a corresponding one of the scan lines Sₙ-Sₙ₊₄, the first source/drain is coupled to a corresponding one of the data lines Dₘ-Dₘ₊₂, and the second source/drain is coupled to the corresponding first sub-pixel 60 and the first source/drain of the corresponding second transistor M2. For each second transistor M2, the gate is coupled to a corresponding one of the scan lines Sₙ-Sₙ₊₄, and the second source/drain is coupled to the corresponding second sub-pixel 62.

For example, referring to FIGS. 5 and 6, the first transistor M1 located at the top left corner of the figures has a gate that is coupled to the scan line Sₙ₊ᵢ, a first source/drain that is coupled to the data line Dₘ, and a second source/drain that is coupled to the first sub-pixel 60 at the top left corner and the first source/drain of the second transistor M2 at the top left corner. In addition, the second transistor M2 at the top left corner has a gate that is coupled to the scan line Sₙ, and a second source/drain that is coupled to the second sub-pixel 62 at the top left corner.

The gates of the first transistors M1 and the second transistors M2 that are coupled to each other are respectively coupled to two adjacent scan lines (for example, the scan lines Sₙ and Sₙ₊₁). The scan lines are driven to a high voltage level at specified time periods to turn on the first transistors M1 and the second transistors M2 so that the voltages on the data lines Dₘ-Dₘ₊₂ can be supplied to the first sub-pixels 60 and the second sub-pixels 62. When the coupled first transistors M1 and second transistors M2 are turned on, the voltages on the data lines Dₘ-Dₘ₊₂ are supplied to the second sub-pixels 62 through the first sub-pixels 60. In the active matrix display 50, each column of first sub-pixels 60 share the same one of data lines Dₘ-Dₘ₊₂ with one column of the second sub-pixels 62. Compared to a conventional active matrix display, the active matrix display 50 can have a greater aperture ratio because the number of data lines is reduced, allowing the viewable regions of pixels to be larger.

In order to describe the method for driving the active matrix display 50 more clearly, the first sub-pixels 60, the second sub-pixels 62, the first transistors M1, and the second transistors M2 in the active matrix display 50 in each row are assigned with more specific reference numerals so that they can be clearly distinguished.

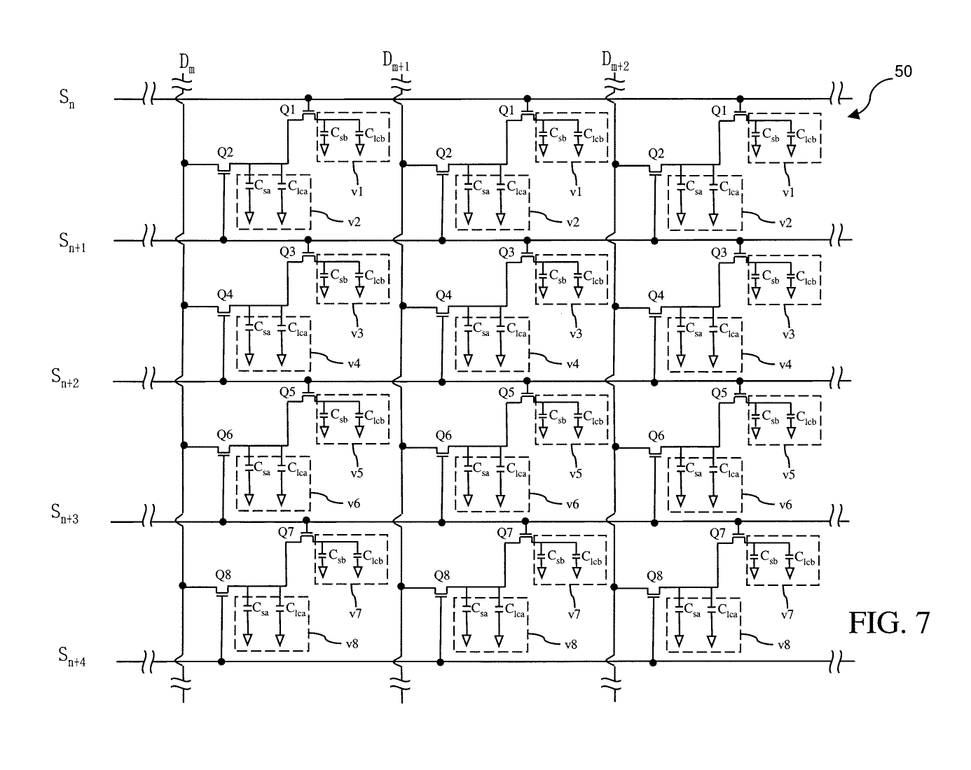

Referring to FIG. 7, the second sub-pixels 62 in the first, second, third, and fourth rows are respectively referred to as sub-pixels v1, v3, v5, and v7, and the first sub-pixels 60 in the first, second, third, and fourth rows are respectively referred to as sub-pixels v2, v4, v6, and v8. The second transistors M2 in the first, second, third, and fourth rows are respectively referred to as transistors Q1, Q3, Q5, and Q7, and the first transistors M1 in the first, second, third, and fourth rows are respectively referred to as transistors Q2, Q4, Q6, and Q8.

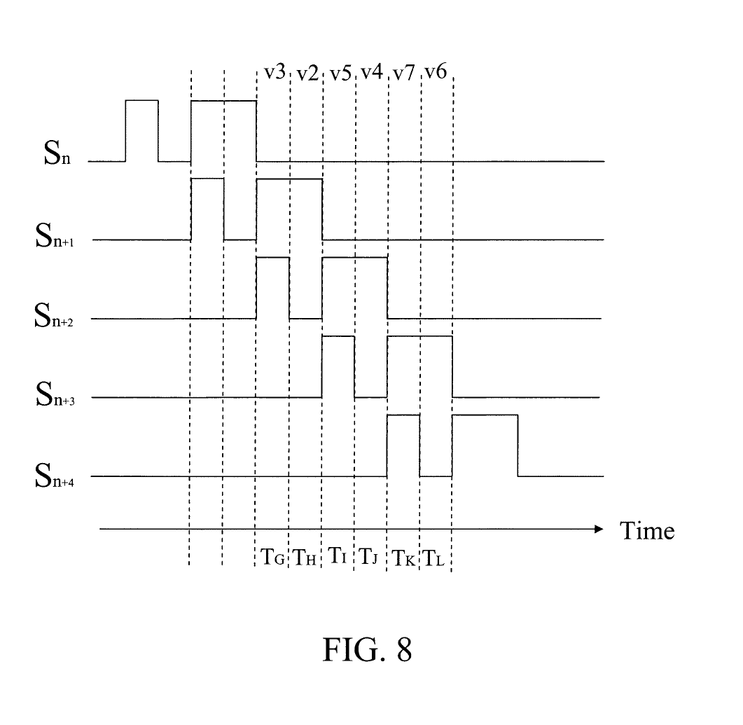

FIG. 8 is a timing diagram of control signals on the scan lines of the active matrix display 50. Referring to FIGS. 5, 7, and 8, taking scan periods T_{G}-T_{L} as an example, during the scan period T_{G}, the control signals on the scan lines Sₙ₊₁ and Sₙ₊₂ are at a high voltage level so that the transistors Q2, Q3, Q4, and Q5 are turned on, and the data voltages on the data lines Dₘ-Dₘ₊₂ are transferred to the sub-pixels v2, v3, and v4, in which the data voltages on the data lines Dₘ-Dₘ₊₂ are supplied to the second pixel electrodes B of the sub-pixels v3 through corresponding first pixel electrodes A of the sub-pixels v4. During the scan period T_{G}, because the transistors Q5 are turned on while the transistors Q6 are turned off, the charges stored in the sub-pixels v5 and v6 are redistributed and balanced so that the voltage difference between the sub-pixels v5 and v6 is reduced.

During the scan period T_{H}, only the control signal on the scan line Sₙ₊₁ is at the high voltage level. Thus, the transistors Q2 and Q3 are turned on, and the data voltages on the data lines Dₘ-Dₘ₊₂ are transferred to the sub-pixels v2. Because the voltage level on the pixel electrodes B of the sub-pixels v3 and the voltage level on the pixel electrodes A of the sub-pixels v4 have been balanced during the scan period T_{G}, the data displayed by the sub-pixels v3 during the scan period T_{H} is not affected when the transistors Q3 are turned on. Accordingly, during a frame period, the pixel voltages of the sub-pixels v3 and the sub-pixels v2 are respectively updated during the scan periods T_{G} and T_{H}, and the sub-pixels v4 are pre-charged during the scan period T_{G}.

Similar to the steps described above, during the scan period T₁, the control signals on the scan lines Sₙ₊₂ and Sₙ₊₃ are at a high voltage level so that the transistors Q4, Q5, Q6, and Q7 are turned on and the data voltages on the data lines Dₘ-Dₘ₊₂ are transferred to the sub-pixels v4, v5, and v6, in which the data voltages on the data lines Dₘ-Dₘ₊₂ are supplied to the second pixel electrodes B of the sub-pixels v5 through corresponding first pixel electrodes A of the sub-pixels v6. During the scan period T₁, because the transistors Q7 are turned on while the transistors Q8 are turned off, the charges stored in the sub-pixels v7 and v8 are redistributed and balanced and accordingly the voltage difference between the sub-pixels v7 and v8 is reduced.

During the scan period Tⱼ, only the control signal on the scan line Sₙ₊₂ is at the high voltage level. Accordingly, the transistors Q4 and Q5 are turned on, and the data voltages on the data lines Dₘ-Dₘ₊₂ are transferred to the sub-pixels v4. Because the voltage level on the pixel electrodes B of the sub-pixels v5 and the voltage level on the pixel electrodes A of the sub-pixels v6 have been balanced during the scan period T₁, the gray scale level displayed by the sub-pixels v5 during the scan period Tⱼ is not affected when the transistors Q5 are turned on. Accordingly, the pixel voltages of the sub-pixels v5 and the sub-pixels v4 are respectively updated during the scan periods T₁ and Tⱼ, and the sub-pixels v6 are pre-charged during the scan period Tⱼ. Similarly, during the scan periods T_{K} and T_{L}, by controlling the voltage levels on the scan lines Sₙ₊₃ and Sₙ₊₄, the data voltages on the data lines Dₘ-Dₘ₊₂ are transferred to the sub-pixels v7 and v6 so that the voltage levels on the pixel electrodes B and A of the sub-pixels v7 and v6 are updated to cause the liquid crystal rotation angle and light transmittance of each pixel to be updated and show the desired gray scale level.

The display 50 can have the advantage of reducing color shift as compared to a conventional liquid crystal display. In general, because different phase retardations are produced in a liquid crystal layer by incident light entering from different angles, different light transmittances are produced depending on whether a liquid crystal display is viewed directly (i.e., viewing angle equals to 0°) or sideways (i.e., viewing angle is between 0 to 90°). Different viewing angles result in different refraction coefficients and different transmittances, and therefore produce different display brightness. When the viewing angle changes, the amount of changes in transmittances for different colors will also be different. For example, when the viewing angle is 0°, the luminance of red, green, and blue sub-pixels of a color pixel may be 0.2, 0.2, and 0.2 (using a normalized scale in which 0 represents the darkest gray scale and 1 represents the brightest gray scale), and when the viewing angle is 60°, the luminance of the red, green, and blue sub-pixels may be 0.3, 0.35, and 0.38, such that the proportions of red, green, and blue colors change when the viewing angle changes, resulting in color shift. Color shift arises when light rays of different colors (for example, red, green, and blue light) are mixed in different proportions for different viewing angles. In generally, blue light causes greater color shift than green light, and green light causes greater color shift than red light.

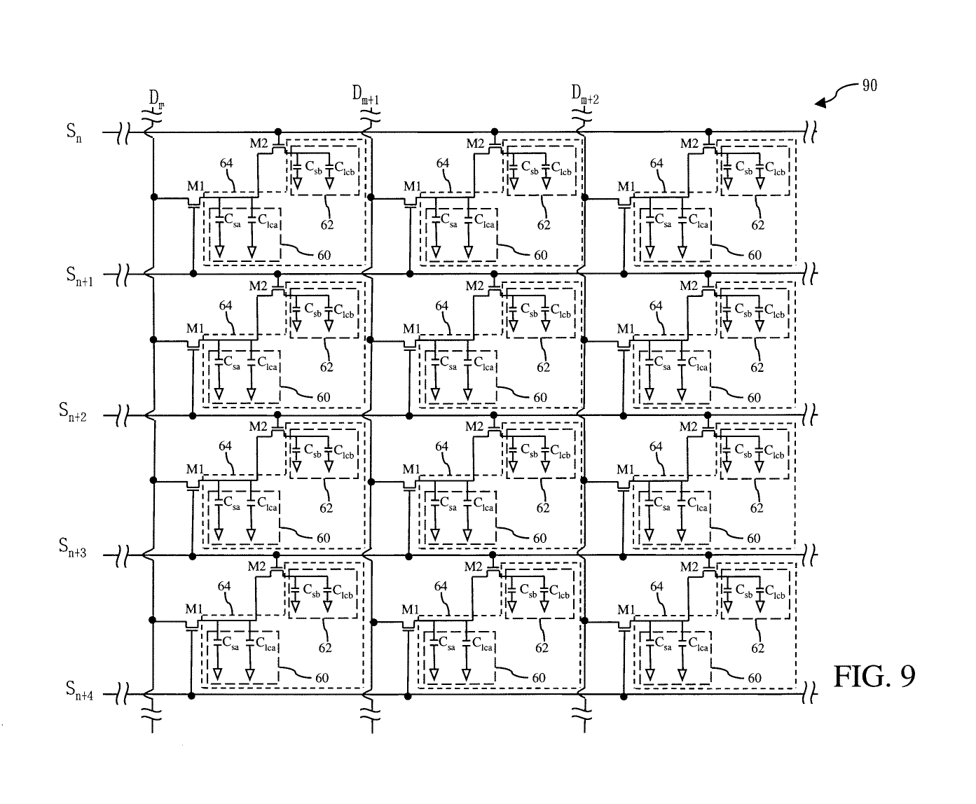

In order to reduce the problem of color shift in a liquid crystal display, in some examples, a pair of the first sub-pixel 60 and second sub-pixel 62 can be combined to form one pixel 64. FIG. 9 is a circuit diagram of an example active matrix display 90 that includes pixels 64 that each has a first sub-pixel 60 and a second sub-pixel 62. Referring to FIG. 9, the active matrix display 90 has a circuit structure that is similar to that of the active matrix display 50 of FIG. 6. In examples where the display 90 is a color display, the first sub-pixel 60 and the second sub-pixel 62 of a single pixel 64 show the same color, whereas two adjacent pixels 64 show different colors.

In some examples, the first sub-pixel 60 and the second sub-pixel 62 of the same pixel 64 are covered by filter layers of the same color so that they can display the same color. Two adjacent pixels 64 are covered by filter layers of different colors so that they display different colors. The first sub-pixel 60 and the second sub-pixel 62 of the same pixel 64 can be configured to display different gray scale levels to reduce the problem of color shift.

For example, in order to allow a pixel 64 to show gray scale level 125, the gray scale value corresponding to the first sub-pixel 60 of the pixel 64 is set to 140, and the gray scale value corresponding to the second sub-pixel 62 is set to 115. Because the first sub-pixel 60 and the second sub-pixel 62 provide different display brightness, a visual compensation effect can be achieved when the pixel is viewed from different viewing angles, so the problem of color shift can be reduced.

The gray scale values corresponding to the first sub-pixel 60 and the second sub-pixel 62 can be adjusted according to various display parameters. For example, the gray scale values may be adjusted according to the surface areas of the pixel electrodes A and B of the first sub-pixel 60 and the second sub-pixel 62. The pixel values corresponding to the first sub-pixel 60 and the second sub-pixel 62 may be exchanged.

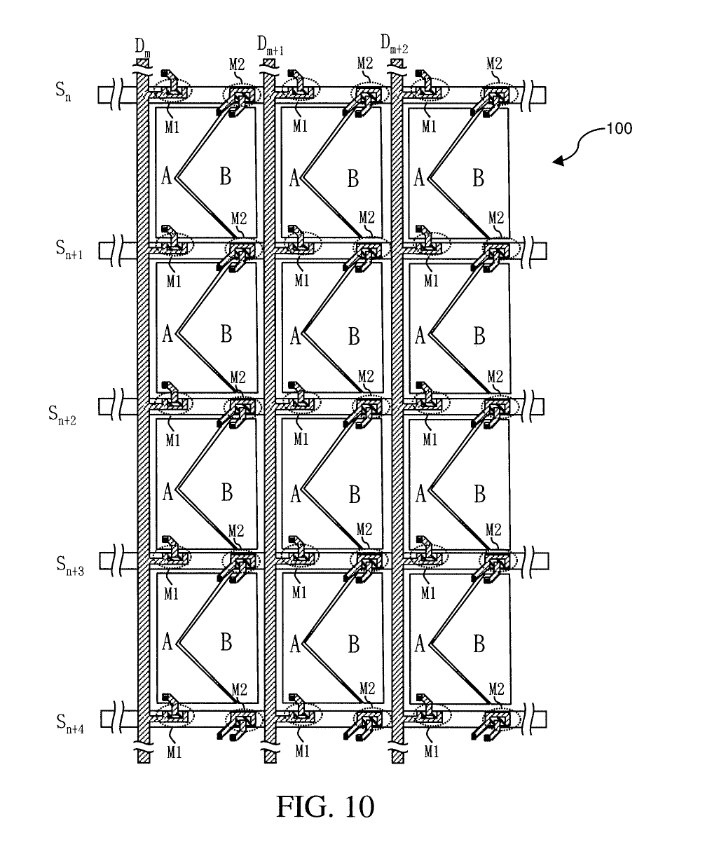

In the example shown in FIG. 5, the pixel electrodes A and the pixel electrodes B have the same shape and size. In some examples, the pixel electrodes A and the pixel electrodes B may have different shapes and sizes. FIG. 10 illustrates the circuit layout of an example active matrix display 100 in which the pixel electrodes A and the pixel electrodes B have different shapes and sizes.

Referring to FIG. 10, the active matrix display 100 has a circuit structure and driving method similar to those of the active matrix display 50 shown in FIG. 5. The difference between the two active matrix displays is in the shapes and sizes of the pixel electrodes A and pixel electrodes B. In this example, the surface area of the pixel electrode A is smaller than the surface area of the pixel electrode B, and the pixel electrodes A and B have different shapes. the pixel electrodes can also have other shapes and sizes. For example, the pixel electrodes A and the pixel electrodes B can be quadrangles having the same length but different widths, so that pixel electrodes A and B are of different sizes.

In the example described above, the second transistors M2 are used for coupling the first pixel electrodes A of the first sub-pixels 60 and the second pixel electrodes B of the second sub-pixels 62 in the same row. In some examples, the second transistors M2 can be used for coupling the first pixel electrodes A of the first sub-pixels 60 and the second pixel electrodes B of the second sub-pixels 62 in two adjacent rows.

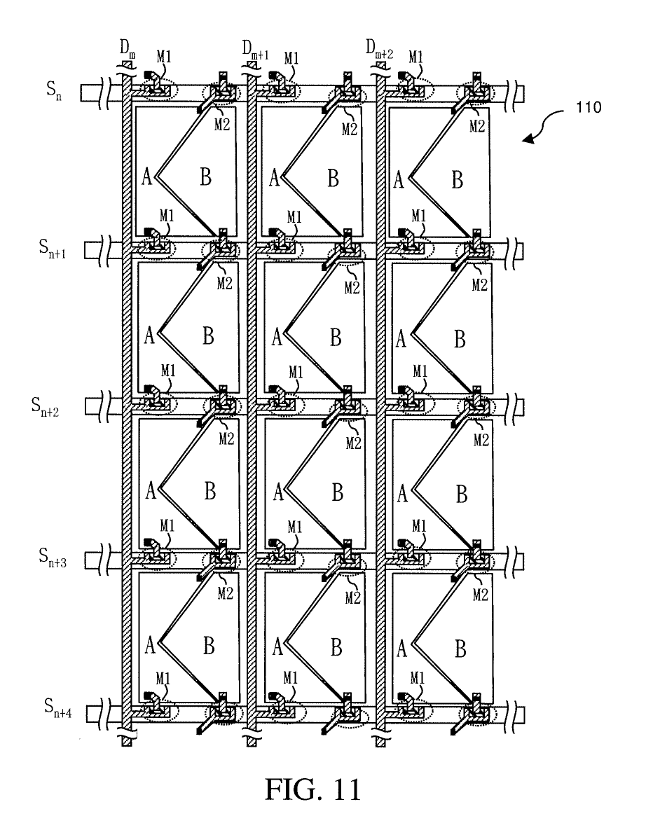

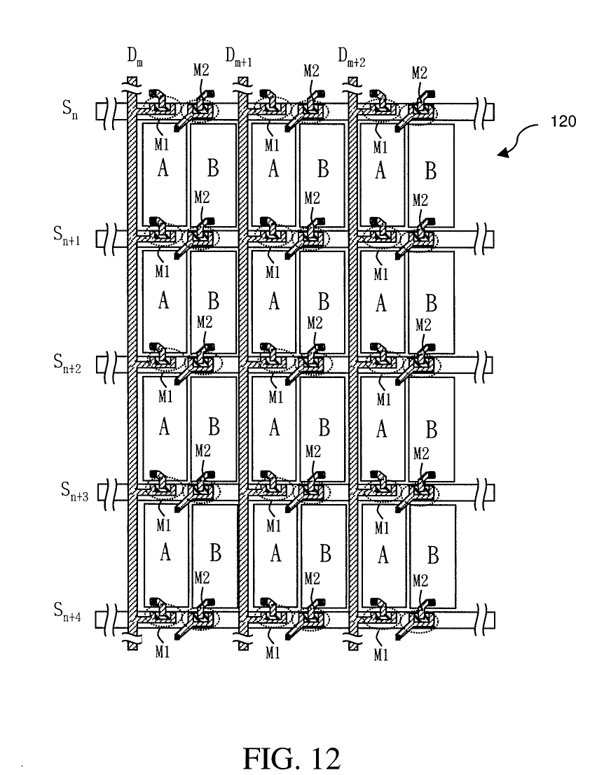

FIG. 11 illustrates the circuit layout of an example active matrix display 110, in which each second transistor M2 couples the first pixel electrode A and the second pixel electrode B located at two sides of a corresponding one of the scan lines Sₙ-Sₙ₊₄. In the example of FIG. 11, the first pixel electrodes A and the second pixel electrodes B have different shapes and sizes. The pixel electrodes can also have other configurations. For example, referring to FIG. 12, the first pixel electrodes A and the second pixel electrodes B can have approximately the same shape and size.

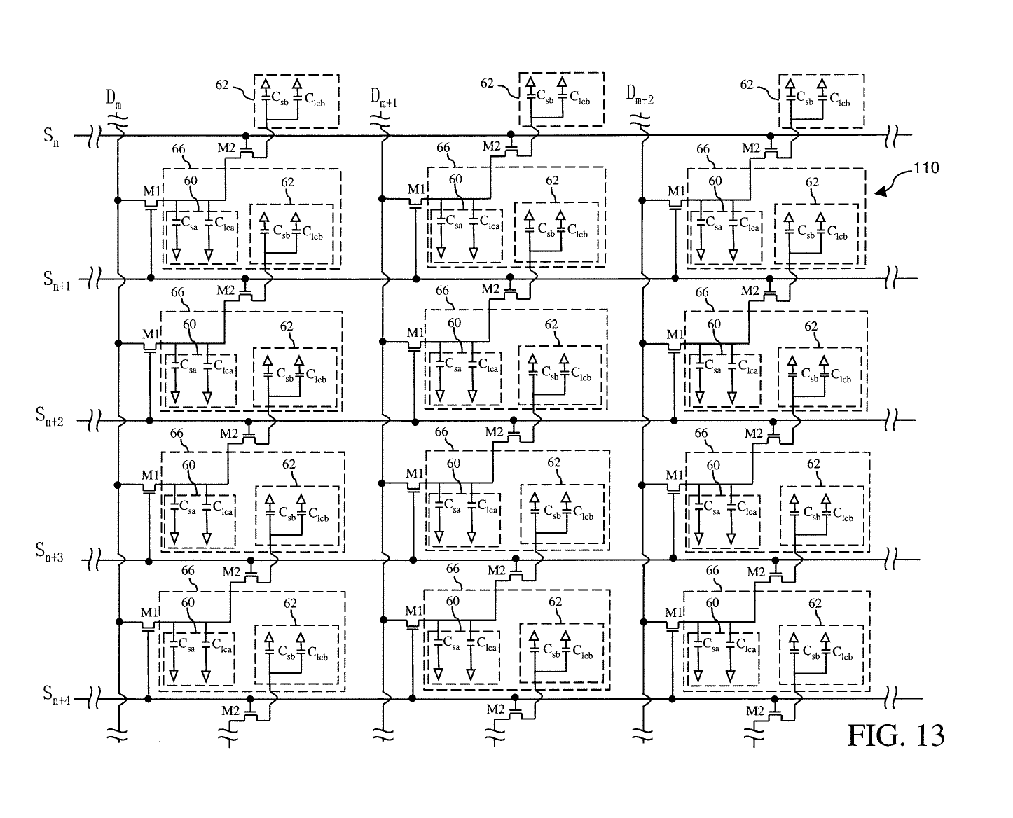

FIG. 13 is a circuit diagram of the active matrix display 110 in FIG. 11. The electrical connections between the elements in the active matrix display 110 are similar to those in the active matrix display 90 (FIG. 9), except for the connection configurations for the second sub-pixels 62. In FIG. 13, each pixel 60 includes a first sub-pixel 60 and a second sub-pixel 62 in the same row, so the problem of color shift can be reduced.

The method for driving the active matrix display 110 is similar to the method for driving the active matrix displays 50 (FIG. 6) and 90 (FIG. 9). In order to describe the method for driving the active matrix display 110 more clearly, the first sub-pixels 60, the second sub-pixels 62, the first transistors M1, and the second transistors M2 in the active matrix display 110 in each row are assigned with more specific reference numerals so that they can be clearly distinguished.

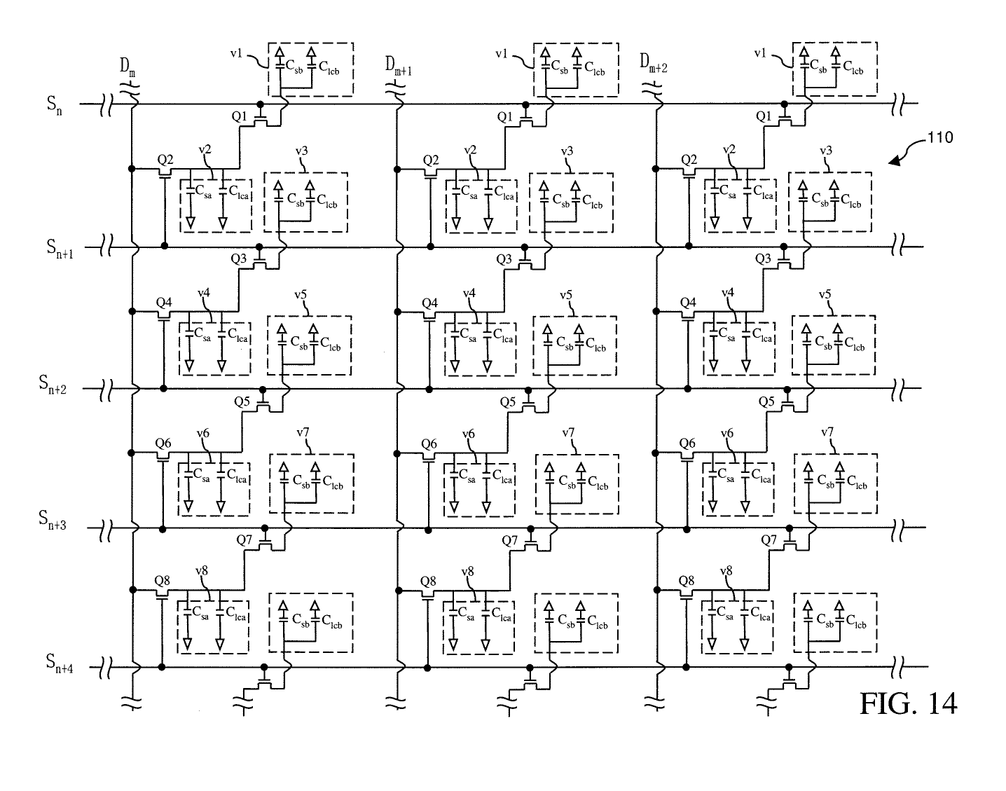

As shown in FIG. 14, the first, second, third, and fourth rows of second transistors M2 are respectively referred to as transistors Q1, Q3, Q5, and Q7, and the first, second, third, and fourth rows of first transistors M1 are respectively referred to as transistors Q2, Q4, Q6, and Q8. The second sub-pixels 62 coupled to the scan lines Sₙ, Sₙ₊₁, Sₙ₊₂, and Sₙ₊₃ through the second transistors M2 (shown as Q1, Q3, Q5, and Q7 in FIG. 14) are respectively referred to as sub-pixels v1, v3, v5, and v7. The first sub-pixels 60 coupled to the scan lines Sₙ₊₁, Sₙ₊₂, Sₙ₊₃, and Sₙ₊₄ through the first transistors M1 (shown as Q2, Q4, Q6, and Q8 in FIG. 14) are respectively referred to as sub-pixels v2, v4, v6, and v8.

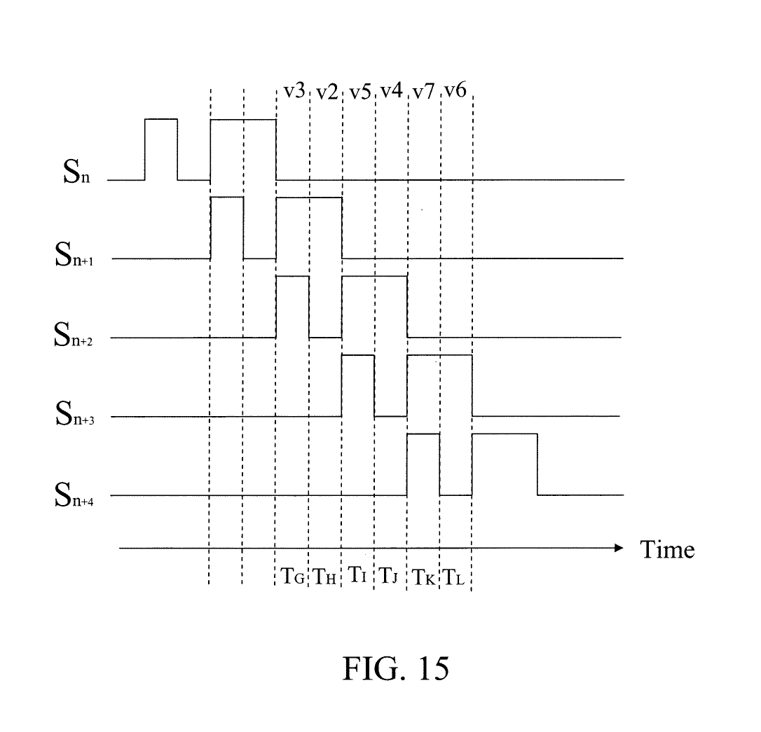

FIG. 15 is a timing diagram of control signals on scan lines of the active matrix display 110. Referring to FIGS. 14 and 15, similar to the active matrix displays 50 and 90, the gray scale values displayed by the sub-pixels v3, v2, v5, v4, v7, and v6 in the active matrix display 110 are respectively updated during the scan periods T_{G}, T_{H}, T_{I}, T_{J}, T_{K}, and T_{L}. During each frame period, the second pixel electrodes B of the sub-pixels v1, v3, v5, and v7 are electrically connected to the data lines Dₘ-Dₘ₊₂ respectively through the transistors Q1, Q3, Q5, and Q7 and the first pixel electrodes A of the sub-pixels v2, v4, v6, and v8, so that the pixel voltages of the second pixel electrodes B of the sub-pixels v1, v3, v5, and v7 can be updated.

In the example described above, every second pixel electrode B is electrically connected to the corresponding data line through the corresponding second transistor M2 and first pixel electrode A. Thus, when the first transistor M1 and the second transistor M2 between the second pixel electrode B and the data line are both turned on, the impedance between the second pixel electrode B and the data line is greater than the impedance between the first pixel electrode A and the data line. As a result, the pixel voltages of some of the second pixel electrodes B may not be updated within a predetermined time.

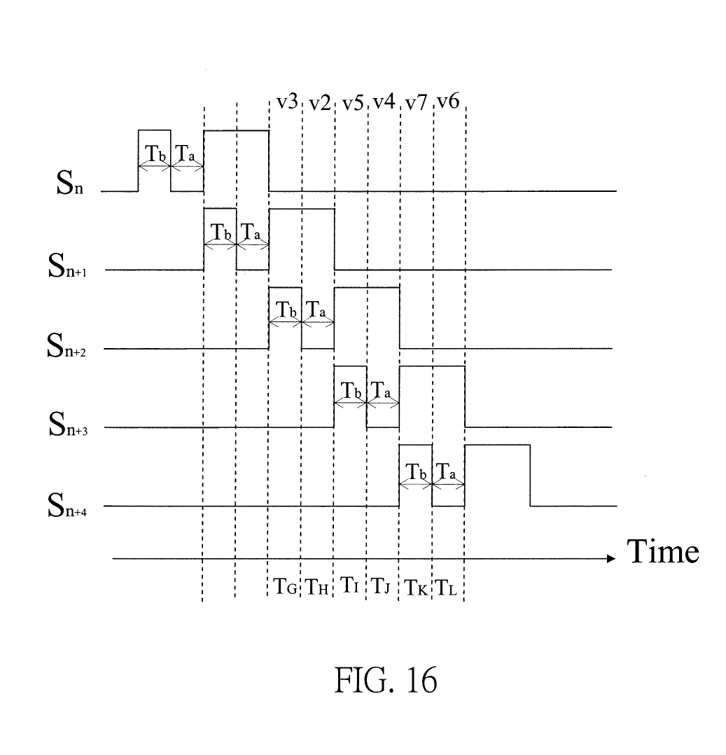

There are several methods to ensure that the pixel voltage of every second pixel electrode B is updated within the predetermined time. One way is to adjust a first scan period and a second scan period corresponding to the first pixel electrodes A and the second pixel electrodes B. FIG. 16 is a timing diagram of control voltages on scan lines of an example active matrix display.

In FIG. 16, each scan period (for example, each of the scan periods T_{G}−T_{L}) is referred to as a first scan period Ta or a second scan period Tb depending to the on/off states of the corresponding first transistor M1 and second transistor M2. During each second scan period Tb, two adjacent scan lines are both at a high voltage level, so that the first transistors M1 and the second transistors M2 coupled to these two adjacent scan lines are turned on and accordingly the pixel voltages of the corresponding first pixel electrodes A and second pixel electrodes B are updated. During each first scan period Ta, only one scan line is at the high voltage level, so that the first pixel electrodes A in a specific row are electrically connected to the data line.

Because the first pixel electrode A is charged during the time period (Ta+Tb), whereas the second pixel electrodes B is only charged during the time period Tb, the second scan period Tb can be increased, and the first scan period Ta can be reduced (e.g., by making the second scan period Tb longer than the first scan period Ta). This way, the first pixel electrode A is still charged for a total time period of Ta+Tb, but the second pixel electrode can be charged for a longer time period Tb.

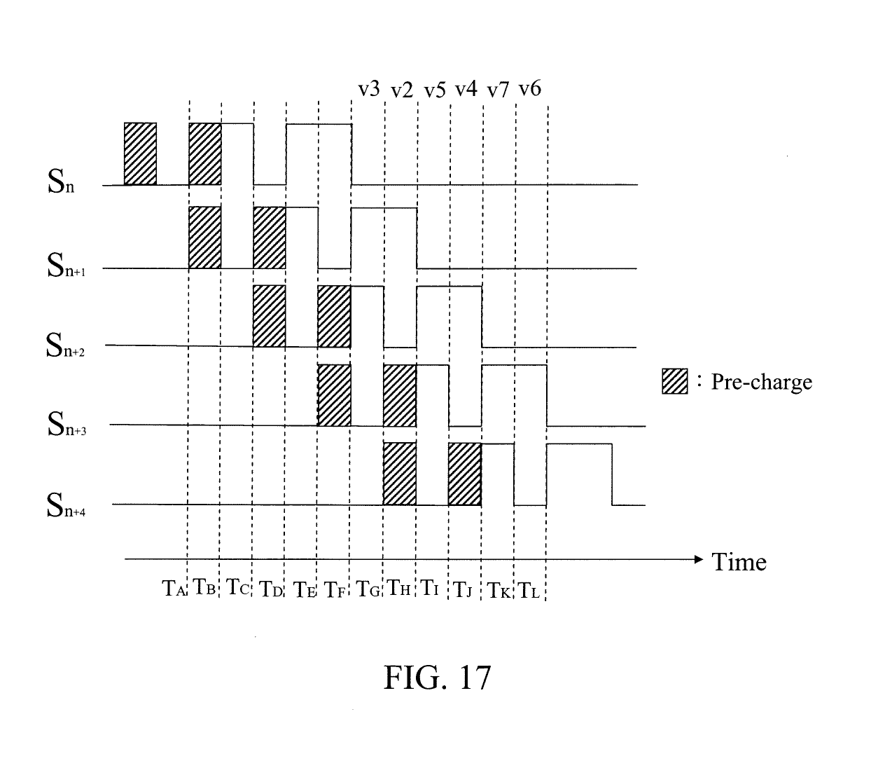

Another method for ensuring that the pixel voltage of each pixel electrode can be updated within a predetermined scan period is to pre-charge the second pixel electrodes B. FIG. 17 is a timing diagram of control voltages on scan lines of an example active matrix display. In the example of FIG. 17, in addition to maintaining each of the scan lines Sₙ-Sₙ₊₄ at a high voltage level during the scan periods similar to the configuration illustrated in FIG. 8, the second pixel electrodes B are pre-charged during the scan periods indicated by diagonal line shading.

For example, for the sub-pixels v3, when both the scan lines Sₙ₊₁ and Sₙ₊₂ are at a high voltage level, the second pixel electrodes B are electrically connected to the data line and are charged accordingly. Thus, in addition to the original charging process during the scan period T_{G}, the second pixel electrodes B of the sub-pixels v3 are also charged during another scan period T_{D}. Similarly, the second pixel electrodes B of the sub-pixels v5 are pre-charged during the scan period T_{F}, and the pixel voltages are updated during the scan period T_{I}. The second pixel electrodes B of the other second sub-pixels can be pre-charged in a similar manner. Pre-charging the second pixel electrode B of each second sub-pixel ensures that the pixel voltage of the second pixel electrode B can be updated within a predetermined scan period.

A conventional active matrix display may have problems caused by “feed through” effects, which may be caused by parasitic gate/drain capacitors C_{gd} and gate/source capacitors C_{gs} between the thin film transistors (TFTs) and the scan lines of the active matrix display. When the voltage on a scan line changes, the voltage on a pixel electrode coupled to the scan line is affected. If different pixel electrodes have different voltage variations, the display brightness of the active matrix display may not be uniform, degrading the image quality of the display.

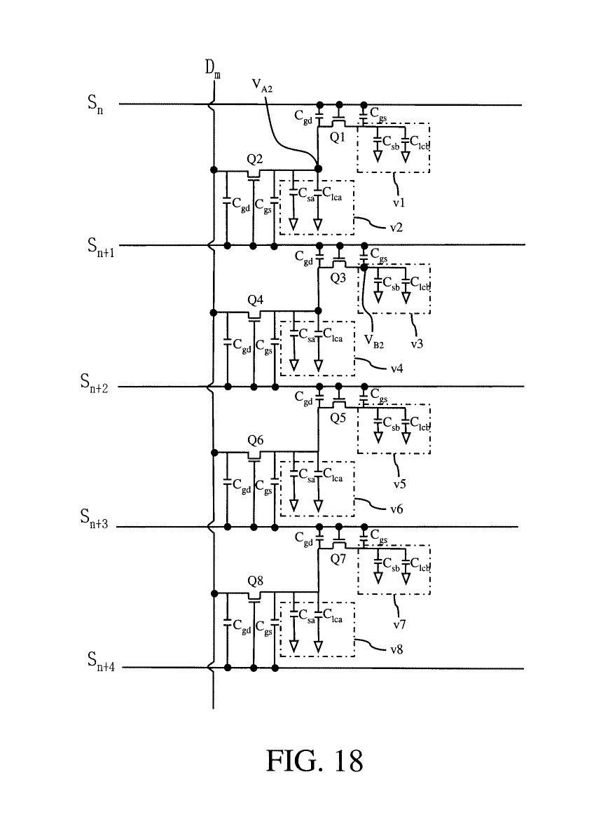

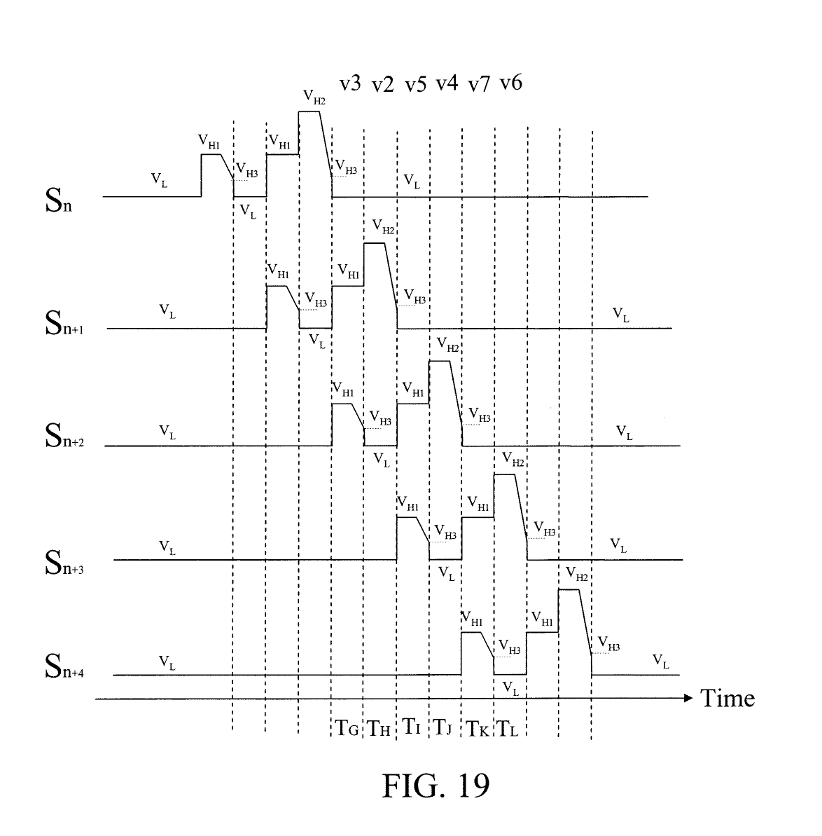

In some examples, in order to reduce the feed through effect, the voltage variation of each pixel electrode is made consistent by controlling the waveform of the scan voltage on each scan line during each scan period. FIG. 18 is a circuit diagram of a portion of an example active matrix display, and FIG. 19 is a timing diagram of scan voltages on the scan lines Sₙ-Sₙ₊₄ in FIG. 18.

In the example of FIG. 18, only one data line Dₘ is shown, but the display can have multiple data lines. Referring to FIGS. 18 and 19, the second sub-pixels coupled to the scan lines Sₙ-Sₙ₊₃ through the transistors Q1, Q3, Q5, and Q7 are referred to as sub-pixels v1, v3, v5, and v7, and the first sub-pixels coupled to the scan lines Sₙ₊₁-Sₙ₊₄ through the transistors Q2, Q4, Q6, and Q8 are respectively referred to as sub-pixels v2, v4, v6, and v8. Each of the transistors Q1-Q8 has a gate/drain capacitor C_{gd} and a gate/source capacitor C_{gs} coupled to the corresponding one of the scan lines Sₙ-Sₙ₊₄.

When the scan lines Sₙ-Sₙ₊₄ are at a low voltage level V_{L}, the transistors Q1-Q8 are turned off. In the example of FIG. 19, when two adjacent scan lines are both at a high voltage level during a given scan period, the voltage level of the two adjacent scan lines is set to a first high level V_{H1}. When only one scan line is at a high voltage level during a given scan period, the voltage level of the scan line is set to a second high level V_{H2}, in which the second high level V_{H2} is higher than the first high level V_{H1}. After each scan period, when the voltage on a scan line drops from the first high level V_{H1} or the second high level V_{H2} to a low voltage level V_{L}, the voltage first drops to a third high level V_{H3} and then to the low voltage level V_{L}, in which the third high level V_{H3} is lower than the first high level V_{H1} and higher than the low voltage level V_{L}.

Taking the scan period T_{G} as an example, the scan lines Sₙ₊₁ and Sₙ₊₂ are first driven to the first high level V_{H1} so that the transistors Q2, Q3, Q4, and Q5 connected to the scan lines Sₙ₊₁ and Sₙ₊₂ are turned on and accordingly the sub-pixels v3 and v4 are charged by the data line Dₘ. When the voltage of the scan line Sₙ₊₂ decreases from the first high level V_{H1} to the low voltage level V_{L}, the voltage on the scan line Sₙ₊₂ first drops to the third high level V_{H3} to reduce the voltage difference between the gate/drain capacitor C_{gd} and the gate/source capacitor C_{gs} of the transistor Q4 and accordingly the voltage drop on the first pixel electrodes A of the sub-pixels v4 when the transistors Q4 are turned off, so that the feed through effect can be reduced or eliminated.

During the scan period T_{H}, when the transistors Q4 are turned off, because the transistors Q3 are still turned on, the voltage on the second pixel electrodes B of the sub-pixels v3 is affected by the voltage drop on the first pixel electrodes A of the sub-pixels v4. To reduce the voltage variation of the second pixel electrodes B caused by such an effect, the voltage on the scan line Sₙ₊₁ is increased from the first high level V_{H1} to the second high level V_{H2} so that the effects of the voltage increase on the scan line Sₙ₊₁ to the pixel electrodes B of the sub-pixels v3 can counteract the effects of the voltage drop on the scan line Sₙ₊₂ to the pixel electrodes B. Accordingly, when the scan line Sₙ₊₁ is increased to the second high level V_{H2} while the scan line Sₙ₊₂ is reduced to the low voltage level V_{L}, the pixel electrodes B of the sub-pixels v3 can have a voltage variation close to zero.

Subsequently, before the scan line Sₙ₊₁ drops to the low voltage level V_{L} from the second high level V_{H2}, the scan line Sₙ₊₁ first drops to the third high level V_{H3} to reduce the voltage difference between the gate/drain capacitor C_{gd} and the gate/source capacitor C_{gs} of the transistor Q3 and the voltage drop on the second pixel electrodes B of the sub-pixels v3 when the transistors Q3 are turned off, so that the feed through effect can be reduced or eliminated. Because the voltages on the scan lines Sₙ₊₂ and Sₙ₊₁ both drop from the third high level V_{H3} to the low voltage level V_{L} when the scan periods T_{G} and T_{H} are about to end, the voltage variations of the sub-pixels v3 and v4 caused by the voltage drop of the scan lines Sₙ₊₁ and Sₙ₊₂ are substantially the same. This way, the image quality of the active matrix display can be improved.

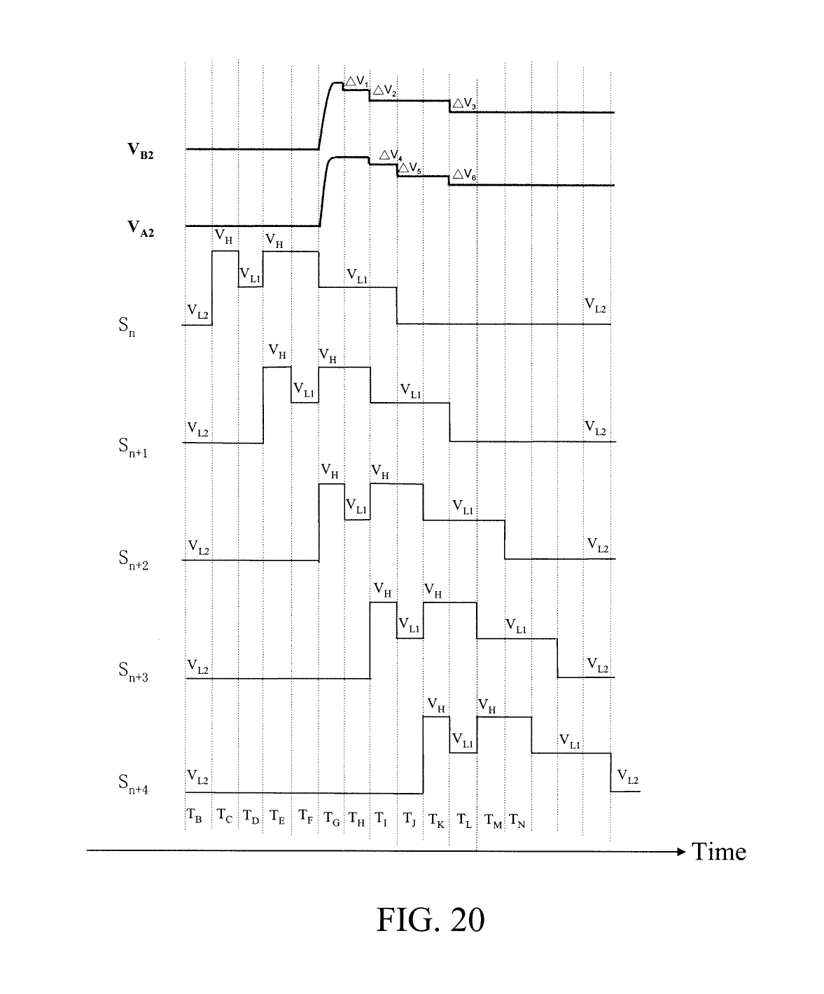

The following describes another method for reducing or eliminating the effects of feed through on the image quality. FIG. 20 is a an example timing diagram of scan voltages on scan lines Sₙ-Sₙ₊₄. Referring to FIG. 20 and FIG. 18, during each frame period, the voltage on each of the scan lines Sₙ-Sₙ₊₄ is increased from a second low level V_{L2} to a high voltage level V_{H} and then reduced from the high voltage level V_{H} to a first low level V_{L1} after a scan period, in which the first low level V_{L1} is higher than the second low level V_{L2}, and the second low level V_{L2} is negative. When the scan voltage on any scan line is at the first low level V_{L1} or the second low level V_{L2}, the transistor coupled to the scan line is turned off.

After the voltage on each of the scan lines Sₙ-Sₙ₊₄ has been maintained at the first low level V_{L1} for a scan period, the voltage on the scan lines Sₙ-Sₙ₊₄ is increased from the first low level V_{L1} to the high voltage level V_{H}, and after the voltage is maintained at the high voltage level V_{H} for two scan periods, the voltage on the scan lines Sₙ-Sₙ₊₄ is reduced from the high voltage level V_{H} to the first low level V_{L1}. After a predetermined time (for example, 3 scan periods), the voltage on the scan lines Sₙ-Sₙ₊₄ drop from the first low level V_{L1} to the second low level V_{L2}.

Taking the scan line Sₙ₊₁ as an example, during the scan periods other than the scan periods T_{E}-T_{K}, the scan line Sₙ₊₁ is at the second low level V_{L2}. During the scan periods T_{E}, T_{G}, and T_{H}, the scan line Sₙ₊₁ is at the high voltage level V_{H}. During the scan periods T_{F}, T_{I}, T_{J}, and T_{K}, the scan line Sₙ₊₁ is at the first low level V_{L1}. In order to describe the features of the example clearly, the pixel voltage V_{A2} of the sub-pixels v2 and the pixel voltage V_{B2} of the sub-pixels v3 will be described.

During the scan period T_{G}, the scan lines Sₙ₊₁ and Sₙ₊₂ are both at the high voltage level V_{H} so that the transistors Q2, Q3, Q4, and Q5 are turned on and accordingly the pixel voltages V_{A2} and V_{B2} are respectively increased to the voltage of the data line Dₘ. When transitioning from the scan period T_{G} to the scan period T_{H}, the scan line Sₙ₊₁ is still maintained at the high voltage level V_{H}, and the voltage of the scan line Sₙ₊₂ drops from the high voltage level V_{H} to the first low level V_{L1}, so that the transistors Q2 and Q3 remains on and the transistors Q4 and Q5 are turned off. Due to the feed through effect of the transistors Q4, a voltage drop ΔV₁ is produced on the pixel voltage V_{B2}, in which the voltage drop ΔV₁ is expressed as:

$$Δ {V}_{1} = ( {V}_{H} - {V}_{L 1} ) \times \frac{{C}_{gs}}{( {C}_{gs} + {C}_{sa} + {C}_{1 ca} ) + ( {C}_{gd} + {C}_{gs} + {C}_{sb} + {C}_{1 cb} )} .$$

When transitioning from the scan period T_{H} to the scan period T₁, the scan line Sₙ₊₁ drops from the high voltage level V_{H} to the first low level V_{L1}. Due to the feed through effect of the transistors Q2 and Q3, a voltage drop ΔV₄ and a voltage drop ΔV₂ are respectively produced on the pixel voltages V_{A2} and V_{B2}, in which the voltage drops ΔV₄ and ΔV₂ are respectively expressed as:

$$Δ {V}_{4} = ( {V}_{H} - {V}_{L 1} ) \times \frac{{C}_{gs}}{{C}_{gd} + {C}_{gs} + {C}_{sa} + {C}_{1 ca}} , \\ Δ {V}_{2} = ( {V}_{H} - {V}_{L 1} ) \times \frac{{C}_{gs}}{{C}_{gs} + {C}_{sb} + {C}_{1 cb}} .$$

When transitioning from the scan period T₁ to the scan period T_{J}, the voltage on the scan line Sₙ changes from the first low level V_{L1} to the second low level V_{L2}. Due to the feed through effect of the transistors Q1, a voltage drop ΔV₅ is produced on the pixel voltage V_{A2}, in which the voltage drop ΔV₅ is expressed as:

$$Δ {V}_{5} = ( {V}_{L 1} - {V}_{L 2} ) \times \frac{{C}_{gs}}{{C}_{gd} + {C}_{gs} + {C}_{sb} + {C}_{1 cb}} .$$

When transitioning from the scan period T_{K} to the scan period T_{L}, the voltage on the scan line Sₙ₊₁ changes from the first low level V_{L1} to the second low level V_{L2}. Due to the feed through effect of the transistors Q2 and Q5, a voltage drop ΔV₆ and a voltage drop ΔV₃ are respectively applied to the pixel voltages V_{A2} and V_{B2}, in which the voltage drops ΔV₆ and ΔV₃ are respectively expressed as:

$$Δ {V}_{6} = ( {V}_{L 1} - {V}_{L 2} ) \times \frac{{C}_{gs}}{{C}_{gd} + {C}_{gs} + {C}_{sa} + {C}_{1 ca}} , \\ Δ {V}_{3} = ( {V}_{L 1} - {V}_{L 2} ) \times \frac{{C}_{gs}}{{C}_{gs} + {C}_{sb} + {C}_{1 cb}} .$$

In some examples, (ΔV₁+ΔV₂+ΔV₃) is configured to be equal to (ΔV₄+ΔV₅+ΔV₆) by adjusting the first low level V_{L1} and the second low level V_{L2}. This way, the feed through effects from the transistors result in the same total voltage drop on the pixel voltages V_{A2} and V_{B2} of the sub-pixels v2 and v3, respectively. This allows the sub-pixels v2 and v3 to have the same brightness.

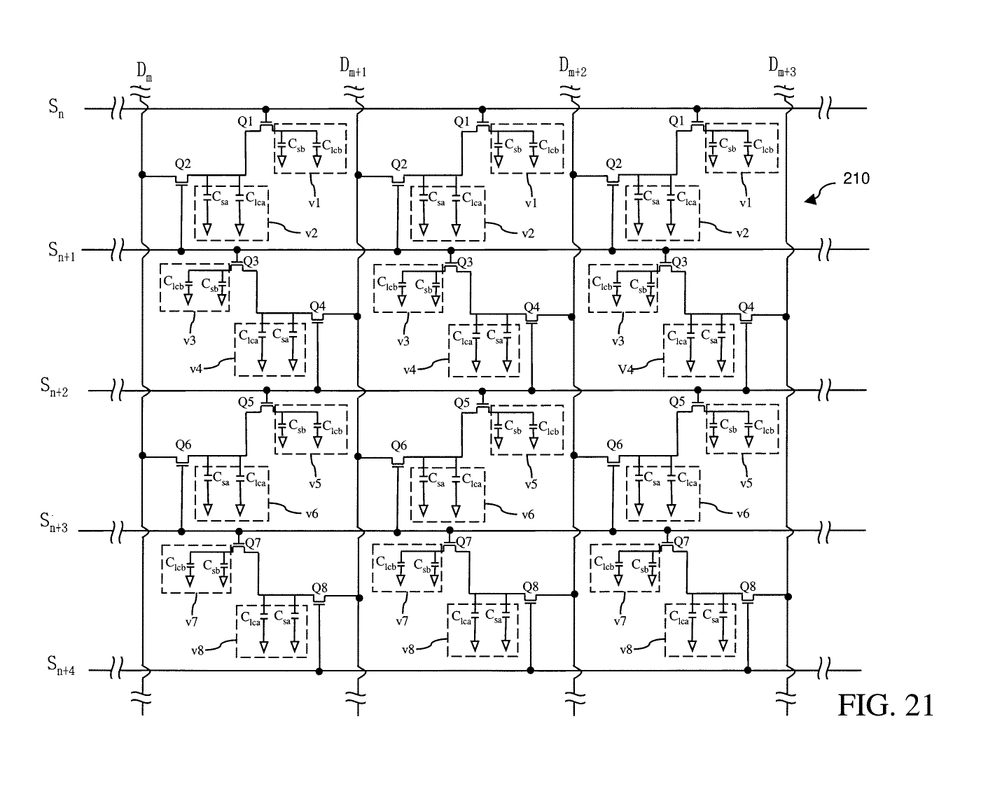

FIG. 21 is a circuit diagram of an example active matrix display 210. Comparing to the display 210 of FIG. 21 to the display 50 of FIG. 7, the active matrix display 210 includes “flip pixels” in which the first transistors (i.e., the transistors Q4 and Q8) in even rows of the active matrix display 210 are coupled to the data lines Dₘ₊₁-Dₘ₊₃, and the first transistors (i.e., the transistors Q2 and Q6) in odd rows of the active matrix display 210 have the same couplings as those in the active matrix display 50.

In the active matrix display 210, the first sources/drains of the transistors Q2 in the first column, the second column, and the third column of the first row are respectively coupled to the data lines Dₘ, Dₘ₊₁, and Dₘ₊₂. The first sources/drains of the transistors Q4 in the first column, the second column, and the third column of the second row are respectively coupled to the data lines Dₘ₊₁, Dₘ₊₂, and Dₘ₊₃. The first sources/drains of the transistors Q6 in the first column, the second column, and the third column of the third row are respectively coupled to the data lines Dₘ, Dₘ₊₁, and Dₘ₊₂. The first sources/drains of the transistors Q8 in the first column, the second column, and the third column of the fourth row are respectively coupled to the data lines Dₘ₊₁, Dₘ₊₂, and Dₘ₊₃.

In some examples, the connections between the first transistors in the odd and even rows of the active matrix display 210 and the data lines Dₘ-Dₘ₊₃ are switched. Namely, the first transistors (i.e., the transistors Q2 and Q6) in the odd rows are coupled to the data lines Dₘ₊₁-Dₘ₊₃, and the first transistors (i.e., the transistors Q4 and Q8) in the even rows have the same couplings as those in the active matrix display 50. To be specific, in this example, the first sources/drains of the transistors Q2 in the first column, the second column, and the third column of the first row are respectively coupled to the data lines Dₘ₊₁, Dₘ₊₂, and Dₘ₊₃. The first sources/drains of the transistors Q4 in the first column, the second column, and the third column of the second row are respectively coupled to the data lines Dₘ, Dₘ₊₁, and Dₘ₊₂. The first sources/drains of the transistors Q6 in the first column, the second column, and the third column of the third row are respectively coupled to the data lines Dₘ₊₁, Dₘ₊₂, and Dₘ₊₃. The first sources/drains of the transistors Q8 in the first column, second column, and third column of the fourth row are respectively coupled to the data lines Dₘ, Dₘ₊₁, and Dₘ₊₂.

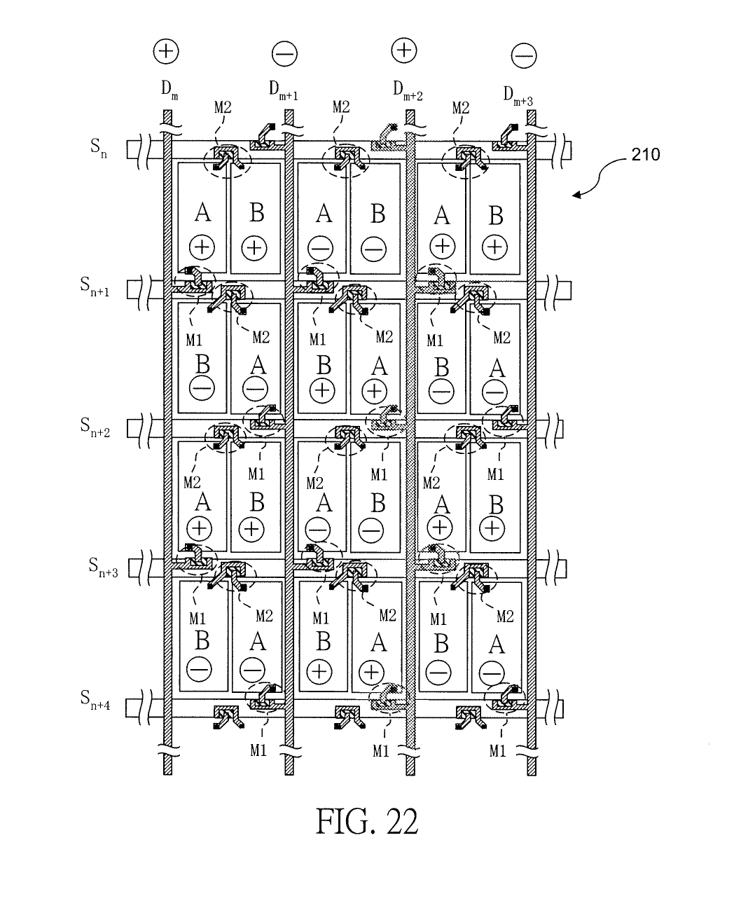

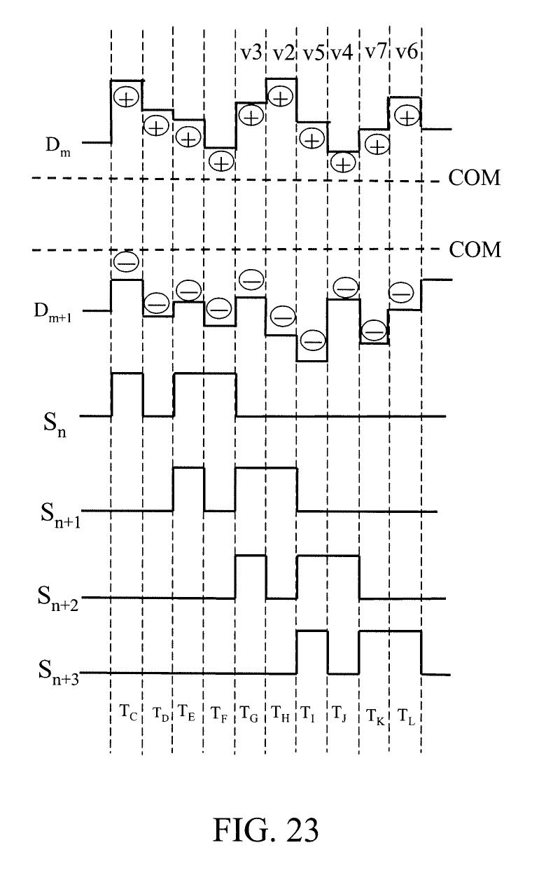

When the active matrix display uses the flip pixel arrangement described above, the polarities of the pixels can be controlled conveniently. A dot inversion effect can be achieved in an active matrix display adopting the flip pixel arrangement through a column inversion polarity control technique. FIG. 22 illustrates the circuit layout of the active matrix display 210, and FIG. 23 is a timing diagram of control signals in the active matrix display 210.

Referring to FIGS. 22 and 23, the pixel electrodes marked with ⊕ have positive polarities, and the pixel electrodes marked with (−) have negative polarities. In this example, during the same frame period, data lines in the odd columns have the same polarity, data lines in the even columns also have the same polarity, and the data lines in the odd columns have a polarity that is opposite to that of the data lines in the even columns. The polarities of the data lines switch once every frame period. For example, if the polarities of the data lines Dₘ and Dₘ₊₂ are positive and the polarities of the data lines Dₘ₊₁ and Dₘ₊₃ are negative during a specific frame period, then the polarities of the data lines Dₘ and Dₘ₊₂ become negative while the polarities of the data lines Dₘ₊₁ and Dₘ₊₃ become positive during a next frame period, and vice versa.

As shown in FIG. 23, during the same frame period, the data line Dₘ has a positive polarity while the data line Dₘ₊₁ has a negative polarity, in which the voltage level marked as COM is the common voltage on a common electrode of the active matrix display 210. During the next frame period, the polarity of the data line Dₘ becomes negative while the polarity of the data line Dₘ₊₁ becomes positive. Namely, during the next frame period, the data voltage on the data line Dₘ is lower than the common voltage COM, while the data voltage on the data line Dₘ₊₁ is higher than the common voltage COM. The voltage levels of the scan lines Sₙ-Sₙ₊₃ during various time periods in FIG. 23 are similar to those of the scan lines Sₙ-Sₙ₊₃ in FIG. 8, and are configured to sequentially charge the first sub-pixels and the second sub-pixels.

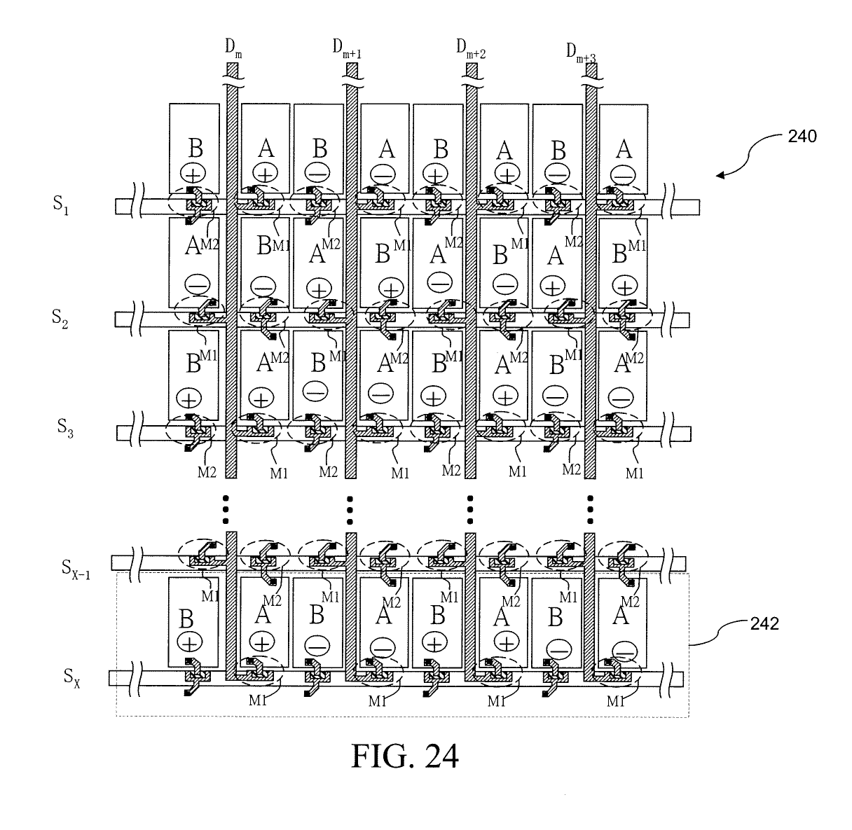

FIG. 24 illustrates the circuit layout of an example active matrix display 240, which also adopts the flip pixel arrangement. However, unlike the second transistors M2 in the active matrix display 210 (FIG. 22) that connect the first pixel electrodes A and the second pixel electrodes B in the same rows, the second transistors M2 in the active matrix display 240 connect the first pixel electrodes A and the second pixel electrodes B in the same columns but different rows.

The active matrix display 240 has a redundant area 242 such that a row of first pixel electrodes A and second pixel electrodes B located above the redundant area 242 can be driven. The pixel polarities of the active matrix display 240 are illustrated in FIG. 24, which shows that within the same row, the first pixel electrodes A and the second pixel electrodes B located at both sides of each data line have the same polarity, and within the same column, each first pixel electrode A has a polarity different from that of the adjacent second pixel electrode B.

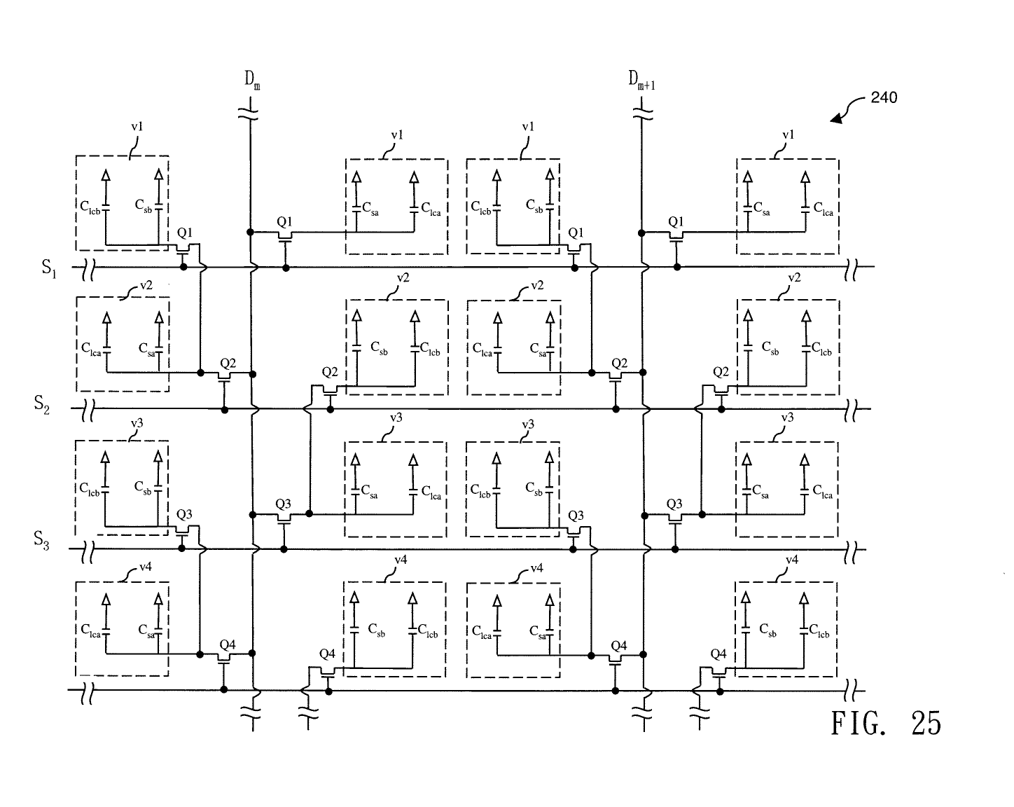

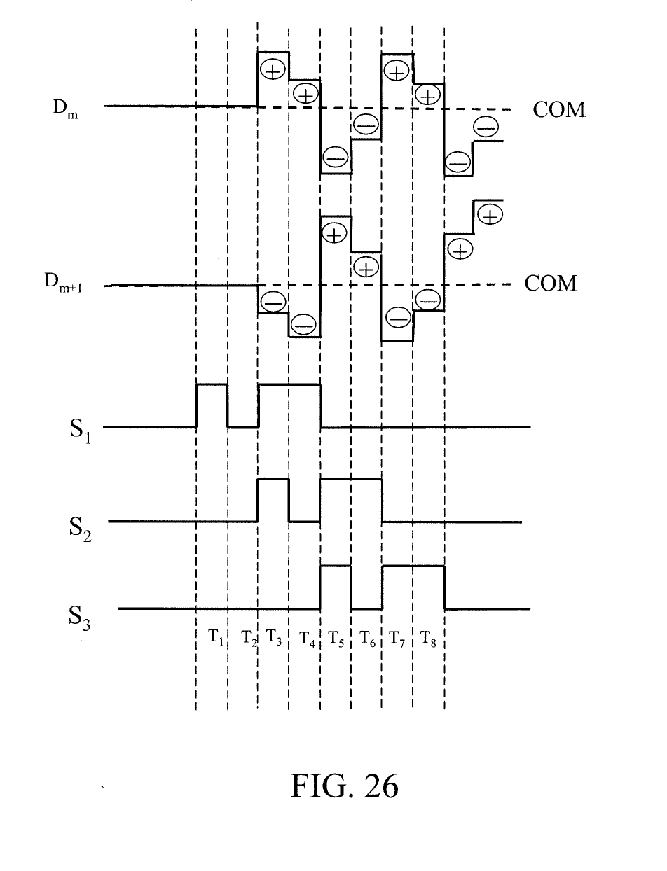

FIG. 25 is a circuit diagram of the active matrix display 240, and FIG. 26 is a timing diagram of control signals in the active matrix display 240. Referring to FIGS. 25 and 26, in this example, the active matrix display 240 adopts a two-line inversion polarity control technique, in which the polarities of the data voltages on the data lines Dₘ-Dₘ₊₁ switch once every two scan periods. For example, during the scan periods T₃ and T₄, the data voltage on the data line Dₘ has a positive polarity, and the data voltage on the data line Dₘ₊₁ has a negative polarity. During the scan periods T₅ and T₆, the data voltage on the data line Dₘ has a negative polarity, and the data voltage on the data line Dₘ₊₁ has a positive polarity.

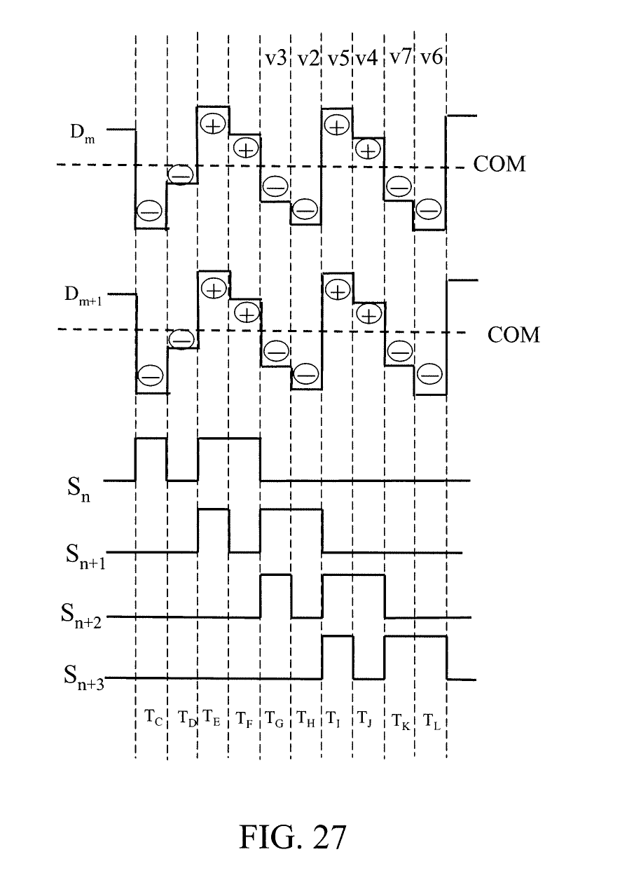

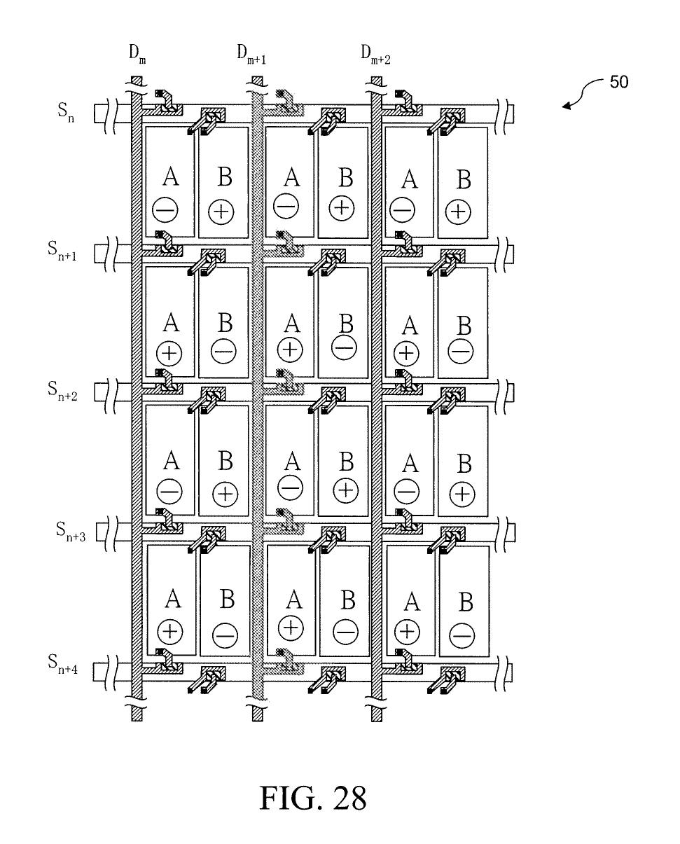

FIG. 27 is a timing diagram of control signals that can be used for the active matrix display 50 in FIG. 5. FIG. 28 illustrates the polarities of pixel electrodes in the active matrix display 50. Referring to FIGS. 27 and 28, the active matrix display 50 adopts the two-line inversion polarity control technique, in which the polarities of the data voltages on the data lines Dₘ-Dₘ₊₂ switch once every two scan periods. The data voltage on each of the data lines Dₘ-Dₘ₊₂ has a polarity different from that of the data voltage on the adjacent data line among the data lines Dₘ-Dₘ₊₂. The polarities of the first pixel electrodes A and the second pixel electrodes B are arranged alternatively. The polarity of each first pixel electrode A is different from the polarity of the adjacent second pixel electrode B in the same row and also different from the polarity of the adjacent first pixel electrode A in the same column. The polarity of each second pixel electrode B is different from the polarity of the adjacent first pixel electrode A in the same row and also different from the polarity of the adjacent second pixel electrode B in the same column.

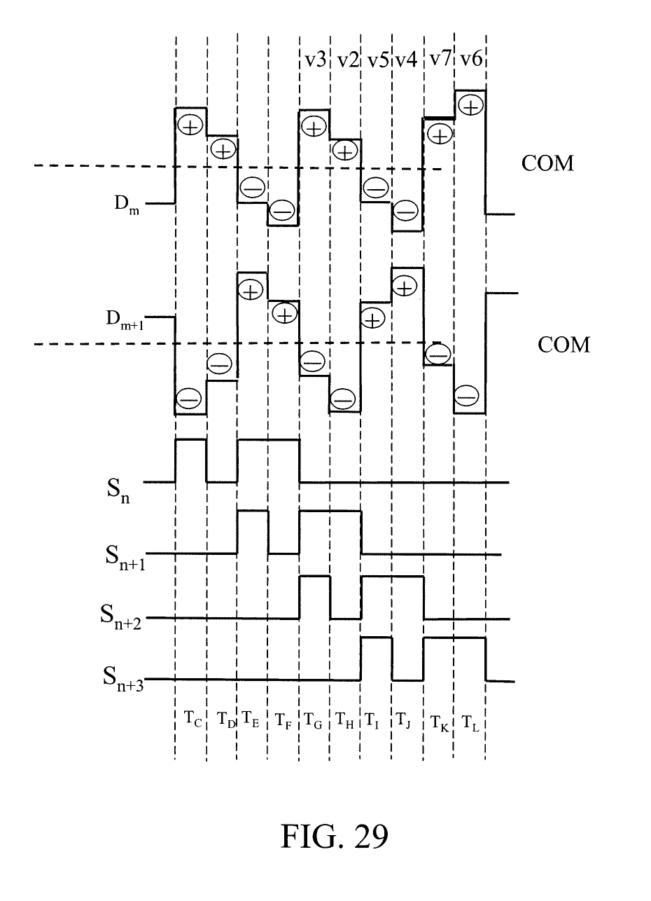

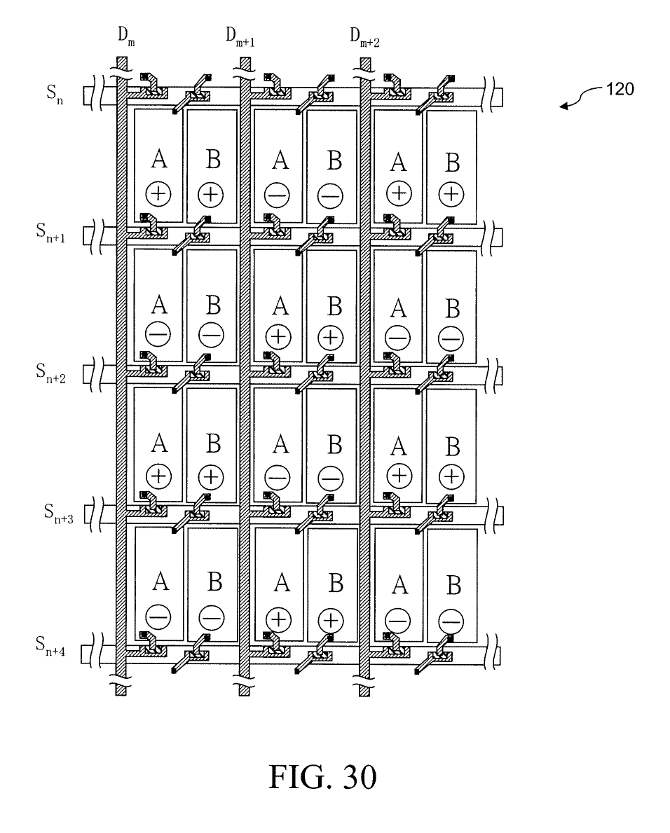

FIG. 29 is a timing diagram of control signals that can be used for the active matrix display 120 in FIG. 12. FIG. 30 illustrates the polarities of pixel electrodes in the active matrix display 120. Referring to FIGS. 29 and 30, the active matrix display 120 adopts the two-line inversion polarity control technique, in which the polarities of the data voltages on the data lines Dₘ-Dₘ₊₂ switch once every two scan periods. The polarity of the data voltage on each of the data lines Dₘ-Dₘ₊₂ is different from the polarity of the data voltage on the adjacent data line. Between adjacent two of the data lines Dₘ-Dₘ₊₂, the first pixel electrode A and the adjacent second pixel electrode B in the same row have the same polarity, and the first pixel electrode A and the adjacent second pixel electrode B in the same column have different polarities.

In the examples described above (e.g., the displays shown in FIGS. 5, 10-12, 22, 24, 28, and 30), a first pixel electrode and an adjacent second pixel electrode in the same row share the same data line, in which the second pixel electrode is electrically connected to the data line through the first pixel electrode, and the action of each pixel is controlled by using only one switch. This way, the number of data lines and the number of switches are reduced, the fabricating cost of the active matrix display can be reduced, and the aperture ratio can be increased.

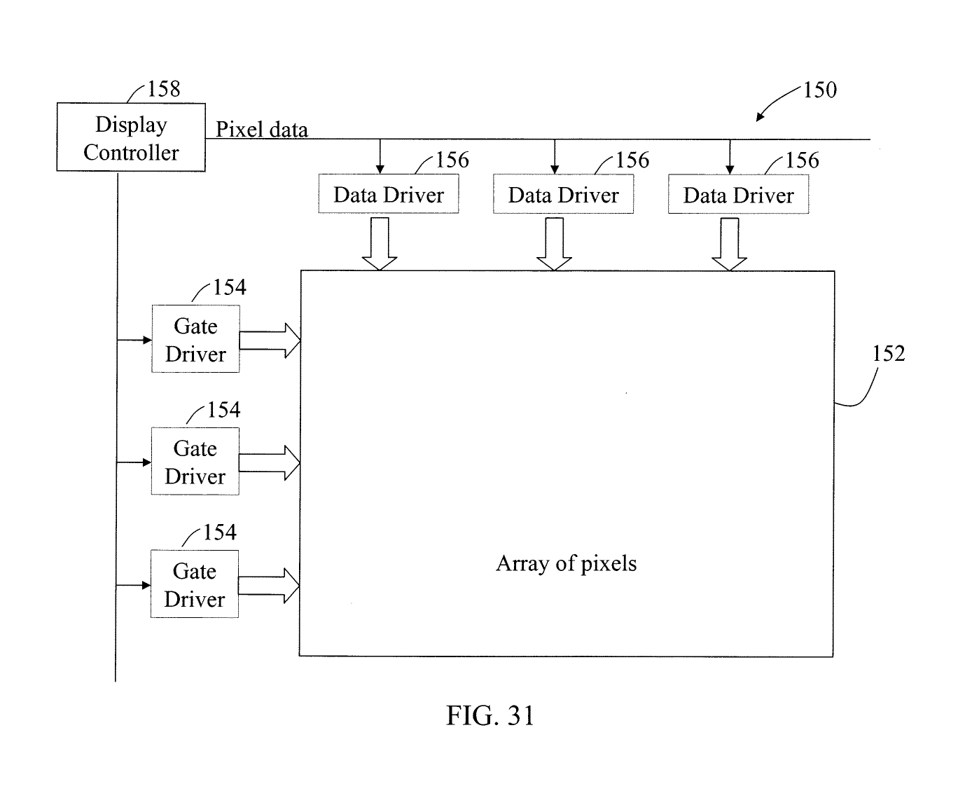

FIG. 31 is a schematic diagram of an example liquid crystal display panel 150, which includes an array 152 of pixels that are controlled by one or more gate drivers 154 and one or more data drivers 156. The array 152 of pixels can have configurations similar to those shown in, e.g., FIG. 5-7, 9-14, 18, 21, 22, 24, 25, 28, or 30. The gate drivers 154 and data drivers 156 are controlled by a display controller 158. The gate drivers 154 drives the scan lines such as Sₙ, Sₙ₊₁, Sₙ₊₂, Sₙ₊₃, and Sn+4, and the data drivers 156 drive the data lines such as Dₙ, Dₙ₊₁, and Dₙ₊₂.

In some examples, the pixels each includes a color filter layer (which can be red, green, or blue) to enable the pixel to show color. By varying the gray levels of the red, green, and blue pixels, a variety of colors can be produced.

The gate drivers 154, the data drivers 156, and the display controller 158 can be configured to drive the scan lines and data lines according to the timing diagrams shown in, e.g., FIGS. 8, 15-17, 19, 20, 23,26, 27, and 29.

A number of examples of the invention have been described. Nevertheless, it will be understood that various modifications may be made without departing from the spirit and scope of the invention. Other implementations and applications are also within the scope of the following claims.

What is claimed is:

1. An active matrix display, comprising:
a first pixel electrode;
a second pixel electrode;
a data line;
a first scan line for controlling an electrical connection between the first pixel electrode and the data line;
a second scan line for controlling an electrical connection between the first pixel electrode and the second pixel electrode; and
driving circuitry to control the first scan line, the second scan line, and the data line to drive the first pixel electrode using a data voltage having a first polarity and drive the second pixel electrode using a data voltage having a second polarity that is different from the first polarity.

2. The display of claim 1 in which the data voltage applied to each pixel electrode changes every predetermined period of time.

3. The display of claim 2 in which the data voltage applied to each pixel electrode changes every two scan periods.

4. The active matrix display according to claim 1 further comprising:
a first transistor, having a source and a drain coupled to the first pixel electrode and the data line and a gate coupled to the first scan line; and
a second transistor, having a source and a drain coupled to the first pixel electrode and the second pixel electrode and a gate coupled to the second scan line.

5. The active matrix display according to claim 1, wherein the first pixel electrode and the second pixel electrode are disposed between the first scan line and the second scan line.

6. The active matrix display according to claim 1, wherein the first pixel electrode and the second pixel electrode are disposed at different sides of the second scan line.

7. The active matrix display according to claim 1 comprising a plurality of the first pixel electrodes and a plurality of the second pixel electrodes, wherein the first pixel electrodes and the second pixel electrodes are arranged as flip pixels.

8. The active matrix display according to claim 1, wherein the first pixel electrode and the second pixel electrode have different pixel voltages.

9. The active matrix display according to claim 1, wherein the first pixel electrode and the second pixel electrode have areas of different sizes.

10. The active matrix display according to claim 1, wherein a polarity of the data line switches once every frame period.

11. The active matrix display according to claim 1, wherein a polarity of the data line switches once every two scan periods.

12. The active matrix display according to claim 1, wherein the first pixel electrode and the second pixel electrode have a same polarity.

13. The active matrix display according to claim 1, wherein the first pixel electrode and the second pixel electrode have different polarities.

14. The active matrix display according to claim 1, wherein the first pixel electrode and the second pixel electrode are covered by filter layers of a same color.

15. The active matrix display according to claim 1, wherein the first pixel electrode and the second pixel electrode are covered by filter layers of different colors.

16. The active matrix display according to claim 1, wherein during a first scan period, the first pixel electrode is electrically connected to the data line and the second pixel electrode is electrically disconnected from the data line, and during a second scan period, the first pixel electrode and the second pixel electrode are both electrically connected to the data line, wherein the second scan period is longer than the first scan period.

17. The active matrix display according to claim 1, wherein when the first pixel electrode is electrically connected to the data line and the second pixel electrode is electrically disconnected from the data line, the first scan line is at a first high level, and when the first pixel electrode and the second pixel electrode are both electrically connected to the data line, the first scan line and the second scan line are both at a second high level, wherein the second high level is lower than the first high level.

18. The active matrix display according to claim 1, wherein during each frame period, the first scan line and the second scan line drop from a high level to a first low level and then drop from the first low level to a second low level, the first pixel electrode is electrically disconnected from the data line when the first scan line is at the first low level or the second low level, and the second pixel electrode is electrically disconnected from the data line when the second scan line is at the first low level or the second low level.

19. A method for driving an active matrix display, configured to update pixel voltages of a first pixel electrode and a second pixel electrode of the active matrix display, the method comprising:
during a first scan period, maintaining a first scan line and a second scan line of the active matrix display at a high voltage level so that the first pixel electrode is electrically connected to a data line of the active matrix display and the second pixel electrode is electrically connected to the first pixel electrode;
during a second scan period, maintaining the first scan line at a high voltage level and the second scan line at a low voltage level so that the first pixel electrode is electrically connected to the data line and the second pixel electrode is electrically disconnected from the first pixel electrode; and
controlling the data voltages on the data line to drive the first pixel electrode using a data voltage having a first polarity and drive the second pixel electrode using a data voltage having a second polarity that is different from the first polarity.

20. The display of claim 19, further comprising changing the polarity of the data voltage applied to each pixel electrode every predetermined period of time.

21. The display of claim 20 in which changing the polarity of the data voltage comprises changing the polarity of the data voltage applied to each pixel electrode every two scan periods.

22. The method according to claim 19, wherein a first transistor of the active matrix display is turned on when the first scan line is at the high voltage level, and a second transistor of the active matrix display is turned on when the second scan line is at the high voltage level, a source and a drain of the first transistor are coupled to the first pixel electrode and the data line, a gate of the first transistor is coupled to the first scan line, a source and a drain of the second transistor are coupled to the first pixel electrode and the second pixel electrode, and a gate of the second transistor is coupled to the second scan line.

23. The method according to claim 19, wherein the first pixel electrode and the second pixel electrode are disposed between the first scan line and the second scan line.

24. The method according to claim 19, wherein the first pixel electrode and the second pixel electrode are disposed at different sides of the second scan line.

25. The method according to claim 19, wherein the active matrix display comprises a plurality of the first pixel electrodes and a plurality of the second pixel electrodes, and the first pixel electrodes and the second pixel electrodes are arranged as flip pixels.

26. The method according to claim 19, wherein the first pixel electrode and the second pixel electrode have different pixel voltages.

27. The method according to claim 19, wherein the first pixel electrode and the second pixel electrode have areas of different sizes.

28. The method according to claim 19, wherein a polarity of the data line switches once every frame period.

29. The method according to claim 19, wherein a polarity of the data line switches once every two scan periods.

30. The method according to claim 19, wherein the first pixel electrode and the second pixel electrode have a same polarity.

31. The method according to claim 19, wherein the first pixel electrode and the second pixel electrode have different polarities.

32. The method according to claim 19, wherein the first pixel electrode and the second pixel electrode are covered by filter layers of a same color.

33. The method according to claim 19, wherein the first pixel electrode and the second pixel electrode are covered by filter layers of different colors.

34. The method according to claim 19, wherein the second scan period is shorter than the first scan period.

35. The method according to claim 19, wherein when the first pixel electrode is electrically connected to the data line and the second pixel electrode is electrically disconnected from the data line, the first scan line is at a first high level, and when the first pixel electrode and the second pixel electrode are both electrically connected to the data line, the first scan line and the second scan line are both at a second high level, wherein the second high level is lower than the first high level.

36. The method according to claim 19, wherein during each frame period, the first scan line and the second scan line drop from a high voltage level to a first low level and then from the first low level to a second low level, the first pixel electrode is electrically disconnected from the data line when the first scan line is at the first low level or the second low level, and the second pixel electrode is electrically disconnected from the data line when the second scan line is at the first low level or the second low level.

37. An active matrix display, comprising:
a first pixel electrode disposed on a first row and a first column;
a second pixel electrode disposed on a second row and the first column;
a third pixel electrode disposed on the second row and a second column;
a fourth pixel electrode disposed on a third row and the second column;
a first data line to drive the first and second pixel electrodes;
a second data line to drive the third and fourth electrodes;
a first scan line for controlling an electrical connection between the first pixel electrode and the first data line and an electrical connection between the third pixel electrode and the fourth pixel electrode;
a second scan line for controlling an electrical connection between the first pixel electrode and the second pixel electrode; and
a third scan line for controlling an electrical connection between the fourth pixel electrode and the second data line.

38. The display of claim 37 in which the polarity of the data voltage applied to each pixel electrode changes every predetermined period of time.

39. An active matrix display, comprising:
a first data line;
a second data line;
a third data line, the second data line being disposed between the first and third data lines, and there are no other data lines between the first and third data lines;
a first pixel electrode;
a second pixel electrode, the first and second pixel electrodes being disposed between the first and second data lines;
a third pixel electrode;
a fourth pixel electrode, the third and fourth pixel electrodes being disposed between the first and second data lines, the second and third pixel electrodes being adjacent to the second data line and disposed at different sides of the second data line, and the first, second, third, and fourth pixel electrodes all being on a same row;
scan lines; and
driving circuitry to control the first data line, the second data line, the third data line, and the scan lines to drive the first and fourth pixel electrode using a data voltage having a first polarity and drive the second and third pixel electrodes using a data voltage having a second polarity that is different from the first polarity.

40. The display of claim 39 in which the polarity of the data voltage applied to each pixel electrode changes every predetermined period of time.

41. An active matrix display, comprising:
an array of pixel electrodes;
data lines, in which each data line drives pixel electrodes in at least two columns; and
control circuitry to control the data lines to drive the pixel electrodes, in which adjacent data lines provide data voltages having different polarities, and
for a given row of pixel electrodes, two pixel electrodes adjacent to a first data line has data voltages of a first polarity, two pixel electrodes adjacent to a second data line adjacent to the first data line has data voltages of a second polarity that is different from the first polarity.

42. The display of claim 41 in which for a given column of pixel electrodes, two adjacent pixel electrodes has data voltages of different polarities.

43. The display of claim 41, further comprising a first scan line for controlling an electrical connection between a first one of the pixel electrodes and one of the data lines, and a second scan line for controlling an electrical connection between the first one of the pixel electrodes and a second one of the pixel electrodes, in which the first and second ones of the pixel electrodes are disposed at different rows.
